(19) United States
(12) Patent Application Publication
(10) Pub. No.: US 2022/0009346 A1
(43) Pub. Date: Jan. 13, 2022

(54) FUEL FILLER POCKET AND DOOR ASSEMBLY

(71) Applicant: U.S. Farathane Corporation, Auburn Hills, MI (US)

(72) Inventors: Wayne Bland, Fort Gratiot, MI (US); Jonathon Dewey, Auburn Hills, MI (US)

(21) Appl. No.: 17/368,208

(22) Filed: Jul. 6, 2021

Related U.S. Application Data
(60) Provisional application No. 63/048,753, filed on Jul. 7, 2020.

(51) Int. Cl. B60K 15/05

(52) U.S. Cl. CPC B60K 15/05; B60K 2015/0458

(57) ABSTRACT

A vehicle mounted fuel filler pocket and hingedly attachable door assembly, having a housing with an upper rim edge defining a pocket shaped body to which is communicated a fuel filler tube. A door overlays the upper rim edge in a closed position. A hinge bracket secures to an underside location of the door at a first end, the hinge bracket having a widthwise extending pin at a second end which is pivotally supported within circular capture recesses defined in a subset area of the pocket shaped body to permit the door to be pivoted from the upper rim edge to an open position. A detent cam mechanism is provided for biasing the door at each of the closed and open positions.

### CROSS REFERENCE TO RELATED APPLICATIONS

The present application claims the priority of U.S. Ser. No. 63/048,753 filed Jul. 7, 2020.

### FIELD OF THE INVENTION

The present invention relates generally to a pivoting door assembly for revealing a vehicle fuel filler orifice. More specifically, the present invention discloses a fuel filler pocket and fuel door assembly for managing the fuel filler tube and cap on the exterior skin of the vehicle. The present assembly presents several subset innovations for improving performance at reduced cost as well as providing for removal of the door and associated pivoting bracket to allow for painting (such as to better color match a prior painting operation of the vehicle) and subsequent reinstallation.

### DESCRIPTION OF THE BACKGROUND ART

The prior art teaches a variety of fuel filler assemblies for use with a vehicle. A first example is shown in US 2016/0280061 to Desai, which teaches a filler assembly including a housing that can connect to the vehicle and includes a fuel pipe opening. The fuel filler assembly can be connected to the vehicle body with aid of the housing. The fuel pipe opening is provided in the fuel filler assembly to accommodate the fuel pipe through which fuel can be filled to a fuel tank of the vehicle. The fuel filler assembly includes a hinge arm attached to the housing which is capable of closing and opening the fuel filler assembly. The hinge arm acts as a component to close or to open the fuel filler assembly. When the fuel tank is required to be filled, the hinge arm is opened such that fuel can be filled to the fuel tank.

U.S. Pat. No. 7,618,078, to Gerner, teaches a fuel flap with a first fastening element attached to a hinge arm. The hinge arm has a second fastening element co-acting with the first fastening element in order to attach the fuel flap to the hinge arm at a predetermined position. The first fastening element includes at least two approximately parallel fastening ribs, at least one of the ribs having two spaced holes and the other has at least one hole, with the axes of the holes being parallel. The second fastening element includes at least three projections having a cross-section complementary to that of the holes. A resilient portion is formed to the hinge arm which upon engagement of the projection in holes is temporarily deformed and after the engagement of the projections in the holes is deformed back and cooperates with a locking portion of the fuel flap so that the fuel flap is secured.

EP 655360, to Journee, teaches a hinged cover for a vehicle fuel filler inlet and having a hinged flap (10) for closing an opening giving access to a filler cap connected to a filler pipe for a motor vehicle fuel tank, A moving panel (12) is mounted in a hinged fashion on a structural element of the vehicle about an axis (X-X) substantially parallel to the plane of the panel (12), and includes elastically returning the panel to a first stable position of closing the opening and a second stable position for access to the opening.

Leitner, US 2002/0130531 teaches another type of fuel door assembly having a housing that defines an axis of rotation and has a moveable retaining surface that is biased toward the axis of rotation. A fuel door is received in the housing and is rotatable about the axis of rotation between a closed position and an open position. The fuel door has a first cam surface and a second cam surface. The retaining surface contacts the first cam surface and urges the fuel door toward the closed position when the fuel door is at the closed position, and contacts the second cam surface and urges the fuel door toward the open position when the fuel door is at the open position.

### SUMMARY OF THE PRESENT INVENTION

The present invention discloses a vehicle mounted fuel filler pocket and hingedly attachable door assembly, having a housing with an upper rim edge defining a pocket shaped body to which is communicated a fuel filler tube. A door overlays the upper rim edge in a closed position. A hinge bracket secures to an underside location of the door at a first end, the hinge bracket having a widthwise extending pin at a second end which is pivotally supported within a capture recesses defined in a subset area of the pocket shaped body to permit the door to be pivoted away from the upper rim edge to an open position.

A detent cam mechanism is provided for biasing the door at each of the closed and open positions. The detent cam mechanism includes a wedge shaped portion extending from the pivot pin and having first and second concave depressions formed therein which, upon selective alignment with a cam roller tensioner component supported within the body, define each of the closed and open positions. An interior superstructure is configured within the subset area of the pocket shaped body for supporting said cam roller tensioner.

A composite thermoplastic spring is integrated into the interior superstructure underneath the cam roller tensioner, the spring engaging with both the cam roller tensioner and detent profile for providing opening resistance in combination with locking position and closure force. The spring further includes oriented strand fibers not limited to fiberglass, carbon, fiber or Kevlar.

Other features include a recess formed in a lip of the main body proximate the upper rim edge and defining a subset receiving pocket housing for receiving a door actuator component. The component further has a flattened upper end button profile which, upon being contacted by downward pressing of the door, bi-directionally displacing to exert a return bias against the door and, in conjunction with the cam tensioner roller and detent components, to influence the door toward the open position.

Additional features include each of the housing and door being produced as an injection molded article created by multiple shots of a thermoplastic material. The hinge bracket further includes a first subset component secured to the door and which is removably engageable with a second subset component pivotally supported with respect to the pocket shaped body.

Locating features associated with the first subset component are provided which inter-engage with receiving structure associated with the second subset component to secure the door to the assembly. The locating features further include biasing tabs extending from the first subset component which are received within an open opposing end of the second subset component. Side windows are configured in the second subset component proximate the open receiving end, through which are snap engaged the biasing tabs. A living hinge pivot pin retainer system includes a molded living hinge door forming a portion of the subset area of the pocket shaped body and, upon closing, acting as a retainer and bearing surface to the width extending pin end of the hinge bracket.

The door actuator component further includes a pseudo diamond shaped travel passageway formed within a lower region of the component, an elongated tang secured within the subset pocket and having an upper angled end seating within the passageway. An elongated compression pad is supported within a recessed interior of the receiving passageway for exerting a continued upward bias against the upper end button profile during up/down travel of the component against the engaging tang.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective illustration of a fuel filler pocket and door assembly according to a first embodiment of the present invention;

FIG. 2 is a rotated and rear looking perspective of the fuel filler pocket assembly of FIG. 1 depicting the two shot hard/soft material construction of the assembly in combination with the integrated composite thermoplastic spring for providing the opening and closing bias to the hinge attached door;

FIG. 3 is a further partially rotated rear side view of FIG. 2;

FIG. 4 is a forward looking perspective similar to FIG. 1 and depicting the two piece molded hinge subassembly with the supported door pivoted to the open position to revel the interior of the fuel filler pocket including showing the door actuator molded component;

FIG. 5 is a further rotated and side plan view of the assembly in FIG. 4 and depicting the molded door actuator rod from another angle in combination with the disengagement tab for removing the door and first part of the two piece hinge from the overall assembly;

FIG. 6 is a 180° rotated view of FIG. 5 and depicting the living hinge separating the pivotal door hinge supporting portion from a sandwiching rigid portion of the main fuel filler pocket housing in the opened position;

FIG. 7 is a 90° rotated view and downward looking plan view of FIG. 6 and showing each of the two shot molded hinge to fuel door attachment, cam roller tensioner and two shot fuel housing components of the present assembly;

FIG. 8 is an intermediate rotated view between FIGS. 6-7 and better depicting the living hinge of the fuel filler pocket housing, again separating the pivotal door hinge supporting portion from a sandwiching rigid portion of the main fuel filler pocket housing in the opened position;

FIG. 9 is an enlarged and partial plan view of FIG. 7 and better showing the cam roller tensioner feature integrated into the rigid portion of the main fuel filler pocket housing and which receives the pivot pin of the hinge bracket prior to sandwiched engagement of the pivoting door supporting portion;

FIG. 10 is a further rotated and front isometric view with the attachable hinge and door removed and depicting the cam roller tensioner and seating pocket for supporting the door actuating molding component;

FIG. 11 is an enlarged and rotated forward view of the main two shot housing depicted in FIG. 10 with the fuel door and attaching hinge removed;

FIG. 12 is an iso/perspective view of the molded fuel door portion and which exhibits a plurality of attachment tabs, the door being either molded directly with a planar support of a first removable portion of the hinge bracket or adapted to being snap-engaged to the bracket support;

FIG. 13 is a succeeding view to FIG. 12 and showing the first molded hinge bracket portion secured to the inside surface of the fuel door and which includes an array of projecting portions which engage within an opposing open interior of the second molded hinge bracket portion (which is in turn secured to the filler pocket housing via the molded hinge pin) in order to secure the door to the filler pocket housing;

FIG. 14 is a succeeding view to FIG. 13 and depicts the first and second hinge bracket portions attached together with the laterally outwardly biased tabs of the first hinge bracket portion seating through receiving windows defined in side walls defining the open interior of the second hinge bracket, the second hinge bracket portion further including an inner end configured hinge portion integrating a wedge shaped detent component with arcuate recesses defining both door open and closing positions in combination with the cam roller tensioner and integrated composite spring;

FIG. 15 is a rotated downward looking plan view of FIG. 14;

FIG. 16 is a further rotated side plan view similar to that shown in FIG. 14 from another angle;

FIG. 17 is a rotated and rearward looking plan view of the door and hinge assembly in FIG. 16 and better showing the shaping of the door, bracket and hinge from a rearward looking direction;

FIG. 18 is a 180° rotated front plan view of FIG. 17 and depicting the door and two piece hinge from a forward looking direction;

FIG. 19 is a combination cutaway taken along line 19-19 of FIG. 13 and rotated view of the door and first attachable or molded hinge portion and better depicting the profile array of projecting portions, including support pedestal, of the first hinge portion which engage within the opposing open interior of the second molded hinge bracket portion for mounting the door and first molded or snap-engaging hinge portion;

FIG. 20 is a succeeding view to FIG. 19 and illustrating the interior inter-engagement profile established between the opposing engagement arrays of the first and second hinge defining portions of the two piece bracket;

FIG. 21 is a substantially 180° rotated view of FIG. 14 and depicting the second attachable hinge bracket portion in see through fashion in order to better depict the inter-engagement of the first and second bracket portions;

FIG. 22 is an enlarged and partial cutaway perspective depicting the mounting interface established between the arcuate and wedge shaped detent component extending from the pin of the first hinge bracket and in contact with the tensioner component and composite spring integrated into the filler pocket housing with the filler door rotated to the closed position;

FIG. 23 is a partial rotated view of FIG. 22, again with the door in the closed position, and showing the protuberance in the housing defining the cam roller tensioner along with depicting the integrated composite spring from a different perspective;

FIG. 24 is a further rotated and different cutaway depiction of an un-sectioned hinge mounting portion with detent component in combination with the cam roller tensioner component and related interior support structure associated with the filler pocket housing;

FIG. 25 is a side plan view similar to FIG. 22 with the hinge and fuel door pivoted to an open position and corresponding with a second of the arcuate recess locations of the detent cam component of the hinge pin rotating into a resistive seating engagement with the protuberance of the cam roller tensioner;

FIG. 26 is an enlarged partial illustration of the composite thermoplastic spring also depicted in FIG. 2 which is integrated into the fuel filler pocket housing and which can include a combination of fabricated or molded components including a thermoplastic material with oriented strand fibers not limited to fiberglass, carbon fiber or Kevlar®, the cam spring engaging both the cam surface and the inwardly notched open and closed detent positions of the wedge shaped component and further such that the closure force and displacement speed are controlled by the cam geometry;

FIG. 27 is an illustration of the door actuator molded component forming the push-push mechanism and which includes a generally elongated and cylindrical shaped component which is received within a recess pocket form within a receiving lip of the fuel filler housing at an end opposite the hinge pivotal support location, the component further incorporating an arrangement of an upwardly projecting button portion integrally formed into the push-push component, as well as including, in combination, an elongated engagement tang which translates along first and second seating locations defined by a diamond shaped travel profile of the component, and along with an elongated compression pad supported within the recess and exerting a continued upward bias against the button portion during up/down travel of the engaging tang as directed by the integrated travel profile;

FIG. 28 is a rotated view of the molded component of FIG. 27 and depicting a lateral projection for positioning and seating the component within the receiving location defined in the filler pocket housing and as best shown in FIGS. 9-11;

FIG. 29 is a depiction of the door actuator component supported within the receiving location of the filler pocket housing and shown in the extended position;

FIG. 30 is a rotated and end plan view of FIG. 29 and again depicting the component in the extended position;

FIG. 31 is a plan cutaway illustration of the door actuator component and receiving pocket and depicting the elongated engagement tang which travels within the diamond shaped travel profile of the component associated with the extended position of FIGS. 29-30, along with the recess interior supported compression pad for exerting the upward continuous bias against the button portion during the up/down travel of the engaging tang as directed by the integrated travel profile;

FIG. 32 is a rotated perspective of FIG. 31 and again showing the interior tang and compression pad components from another angle;

FIG. 33 is an illustration similar to FIG. 31 and depicting the door actuator component downwardly displaced, concurrent with pressing engagement of the fuel door, to the inner closed position and concurrent with the tang traveling within the diamond shaped travel profile to an upper corner location;

FIG. 34 is an illustration similar to FIG. 32 depicting the component and tang in the open position of FIG. 33;

FIG. 35 is a perspective illustration of a fuel filler pocket and door assembly according to a second embodiment of the present invention;

FIG. 36 is an illustration of the door of FIG. 35 removed from the assembly and including a removable portion of a two piece pivoting bracket, such as which can be produced according to a rotary two shot molding process for molding a bracket supporting portion directly to the inside of the door, with attachment also being obtained through cohesive or mechanical bonding within either of a rotary two shot or pick and place injection mold;

FIG. 37 is a substantial repeat of FIG. 36 and depicting the first and second shot thermoplastic resin portions in combination with the geometrical in mold door fastening tabs associated with the first shot molding operation;

FIG. 38 is an illustration of the filter pocket housing and hinge assembly, with the door removed, and in order to depict the cam spring mechanism including tapered cam and detent system for rotating against either of an in-molded or installed composite spring;

FIG. 39 is a substantial repeat of FIG. 38 and depicting the base component of the hinge structure in the closed position along with the cam feature and composite spring components;

FIG. 40 is a succeeding view to FIG. 39 and showing the door supporting hinge structure rotated to an open position as depicted in FIG. 35, in combination with designating the multi-shot resin material portions as well as depicting the receiving location in the filler pocket housing for supporting the door actuating component;

FIG. 41 is a further side rotated view of FIG. 40 and depicting, from another angle, the cam feature, cam detents and composite spring components;

FIGS. 42-43 provide a pair of illustrations similar to FIG. 38 with the base rotating hinge component removed and in order to better illustrate the composite spring which can again be fabricated or molded utilizing oriented strand fibers such as including not limited to fiberglass, carbon fiber or Kevlar®, the spring being configured to engage with both the cam surface and detent to provide each of opening resistance, locking position and closure force within the operating requirements of the total assembly, with the closure force and speed being controlled by the design cam geometry;

FIG. 44 is a further illustration similar to FIG. 42 and showing an attachable portion for pivotally securing the hinge pin between pin seating locations in the housing and in biasing contact with the composite spring;

FIG. 45 is an illustration of the door portion of FIGS. 36-37 and depicting the snap coupling system for securing the door and inside support portion to the hinge, such as which can be accomplished after separate painting of the door;

FIG. 46 is an illustration similar to FIG. 45 and depicting the hinge in exploded fashion to reveal the snap receptacle features arrayed relative to the molded in snap features of the door inside support portion and tunable stability/locating features for ensuring alignment and correct displacing engagement of the hinge;

FIG. 47 succeeds FIG. 46 and displays the hinge in partial transparency in order to show the snaps engaged with the aligning windows in the sides of the perimeter defining walls of the hinge in combination with the guiding interior travel of the stability/locating features of the molded in portion of the hinge on the door rear surface;

FIGS. 48-49 present a pair of perspective illustrations of a further variant of a fuel filler pocket housing and depicting a variation of a molded in push-push door release mechanism which incorporates a main body actuator housing incorporated into the fuel filler housing;

FIG. 50 is a rotated perspective of FIG. 48 with much of the filler pocket housing shown in transparency and to better illustrate the assembled door release mechanism supported within the molded actuator housing location;

FIGS. 51-52 are a pair of illustrations, similar to FIGS. 6-8 of the first variant, and depicting the living hinge pivot pin retaining system which includes a molded living hinge door forming a portion of the main housing body which, when pivoted closed, acts as a pin retainer with opposing pairs of bearing surfaces for seating therebetween the hinge;

FIG. 53 is a side plan view of the door and hinge in the open rotated position about the living hinge axis and showing the concentric bearing surfaces for supporting the hinge; and

FIG. 54 is an exploded positional depiction of the soft molded components of the fuel filler pocket housing in combination with the push-push door actuator component, composite spring and underside hinge supporting portion associated with the door.

### DETAILED DESCRIPTION OF THE PREFERRED EMBODIMENTS

With reference to the appended illustrations, the present invention provides a fuel filler pocket and fuel door assembly for managing the fuel filler tube and cap on the exterior skin of a vehicle (not shown). As further described herein, the fuel door assembly of the present invention provides for improving performance at reduced cost, as well as enabling removal of the door and associated pivoting bracket after initial manufacture and to allow for painting (such as to better color match a prior painting operation of the vehicle) and ease of subsequent reinstallation.

A first aspect of the present invention presents a door assembly process providing for attachment of the fuel door to a removable portion of a pivoting bracket utilizing a two shot injection molding process for molding the bracket directly onto the door component. Attachment utilizing cohesive or mechanical bonding is accomplished with such as a rotary two shot or pick and place injection mold assembly and which allows for more effective color match painting of dissimilar materials (i.e. the material differences between the fuel door and the surrounding vehicle body often resulting in color match disparities following the initial painting job on the vehicle and which necessitates the ability to easily and efficiently remove the fuel door for color match touch up painting and subsequent reinstallation).

A second aspect of the present invention teaches a cam spring mechanism incorporating a tapered cam and detent system for rotating the door relative to an in-molded or installed composite spring.

A third aspect of the present invention teaches the thermoplastic composite spring construction (either fabricated or molded) utilizing oriented strand fibers not limited to fiberglass, carbon, fiber or Kevlar. The spring engages with both the cam surface and detent of the cam spring mechanism for providing a desired degree of opening resistance in combination with locking position and closure force within the operating requirements of the overall assembly. The closure force and speed exerted by the cam on the attached door is controlled by the cam geometry.

A fourth aspect of the present invention teaches a door bracket mounting system including a snap coupling system for attachment to a previously molded and painted door with the bracket to a fuel filler pocket, such as following an initial vehicle installation.

A fifth aspect of the present invention teaches a molded push-push door release mechanism (also termed molded door actuator rod) which incorporates a main body actuator housing molded into the fuel filler housing, thus eliminating one part and assembly operation required in conventional door assemblies.

A sixth aspect of the present invention teaches a living hinge pivot pin retainer system which discloses a molded living hinge door, forming a portion of the main body and which, upon closing, acts as a pin retainer and bearing surface.

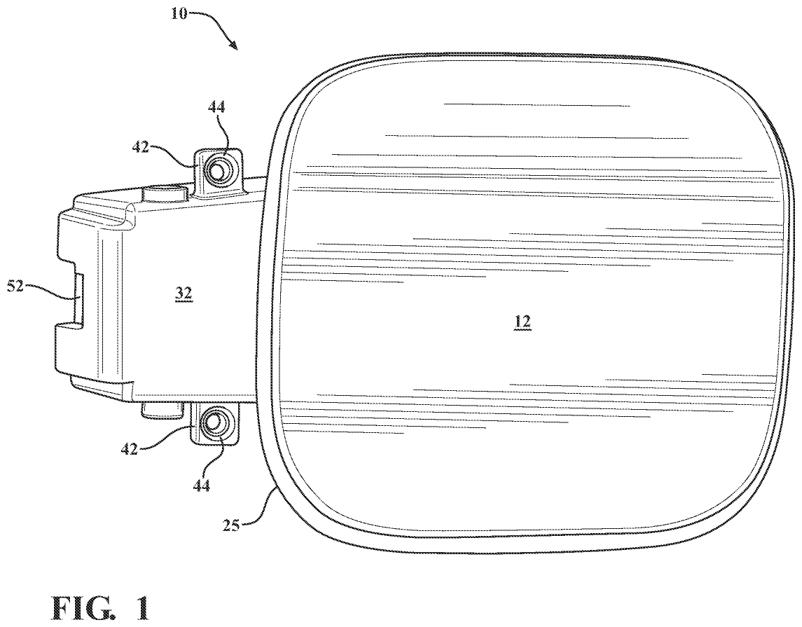

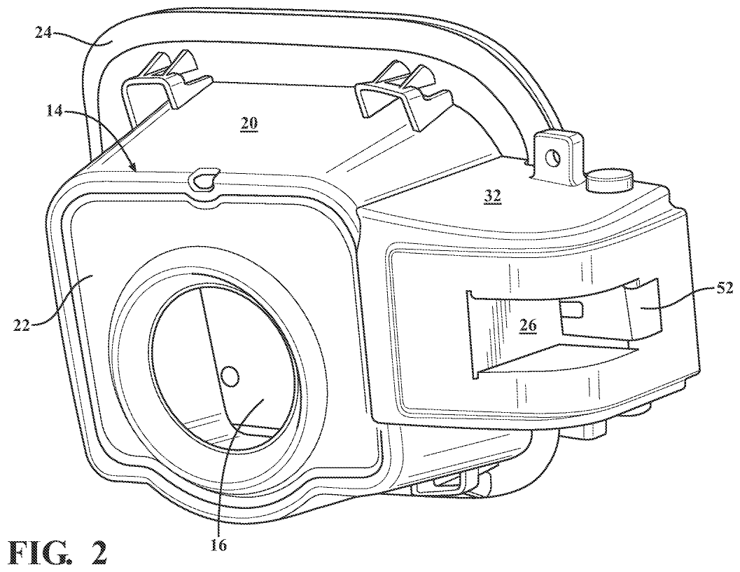

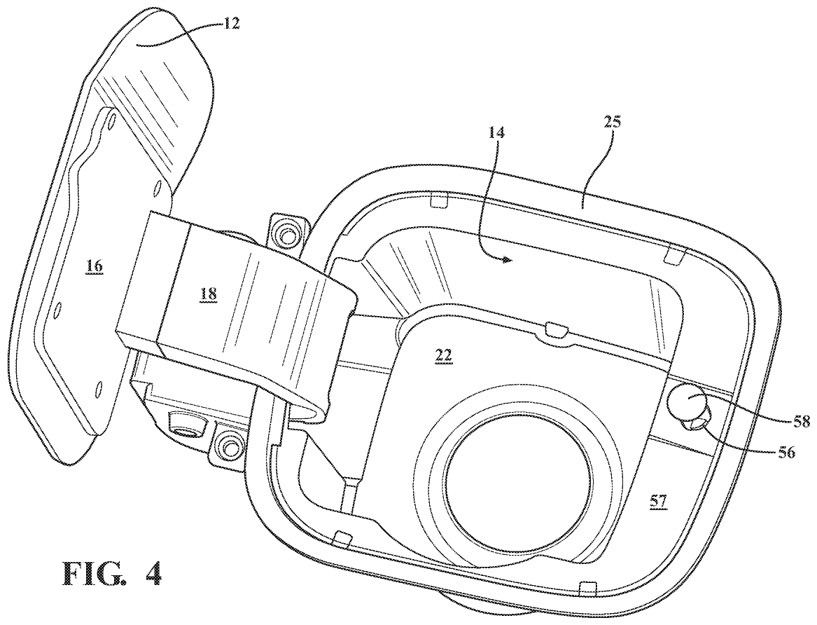

Referring first to FIG. 1, a perspective illustration is generally shown at 10 of a fuel filler pocket and door assembly according to a non-limiting embodiment of the present invention. A door 12 (see also FIG. 4 et seq.) is provided and which is formed of a polymer material, such as by injection molding, in a separate operation. The door exhibits any desired shape or outline, such as shown having a rounded rectangular overall shape however envisioned to include a circular or other shape consistent with the surrounding vehicle outer skin (not shown). The door 12 is attached to a main fuel filler pocket defining housing, see generally as referenced at 14 in FIG. 2, via a two piece molded hinge subassembly, this further best shown in FIG. 4 and including first piece 16 which can be molded or attached to an inside surface of the door and a second piece 18 which engages the first piece 16 at an outer end and which is pivotally mounted to a pivotal location of the housing 14 at a second inner end.

The main housing 14 is constructed of a two shot injection molded plastic material with a first injection molded shot (see FIG. 2 et seq.) of a more rigid material 20 (such as encompassing but not limited to a polypropylene and like material) and which defines a main structural body of the filler pocket housing. One or more second shot injection moldings (see at 22, 24, and 26 in FIG. 2) of a softer plasticized material (such including without limitation a polyethylene based polymer or other material of a softer composition than the first shot material 12) are then provided in a second injection molding step and can include without limitation thermoplastic vulcanizates (TPVs) and thermoplastic olefins (TPO□s) which are part of the thermoplastic elastomer (TPE) family of polymers, but are closest in elastomeric properties to EPDM thermoset rubber, combining the characteristics of vulcanized rubber with the processing properties of thermoplastics.

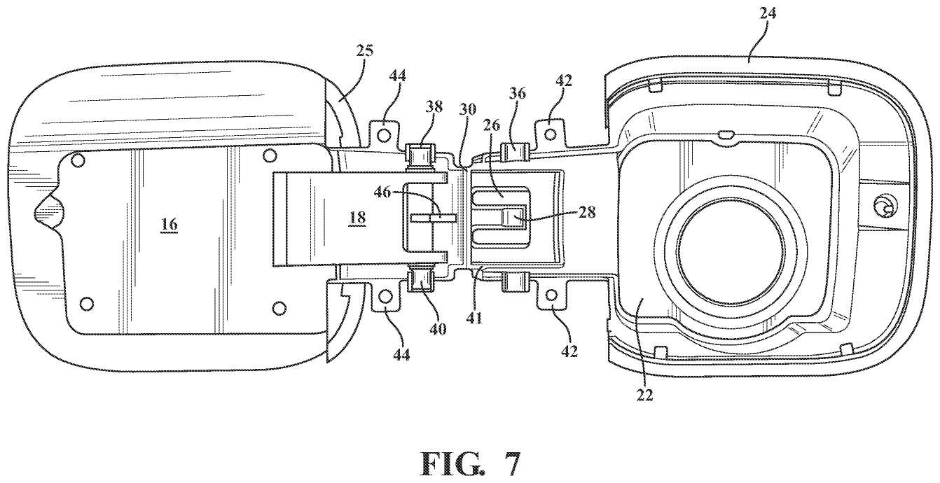

The second (soft) shot material can be formed at varied attachment locations to the previously formed main rigid body 20, and again can include an attachment location for an associated fuel filler pipe, see again shown at 22 and which can include an inner annular defined rim for interconnecting the vehicle fuel filler pipe (not shown). Other concurrently formed second shot injection molded locations also include an inside facing perimeter rim defining the main body of filler housing body (again at 24), with an opposite face 25 defining a similar perimeter location located for contacting an underside of the separately formed rigid fuel door 12 (see in particular each of FIGS. 4 and 7), and upon the door 12 being closed against the main body 20.

In this manner, the second shot injection molding locations 24/25 collectively provide both seating supporting when installed within the vehicle outer skin and support for the hingedly associated door 12 in the closed position. Finally, the soft shot locations can include such as again shown by the □U□ shaped second shot material 26, and which surrounds a cam roller tensioner component (see eccentric shaped and protuberant embossment 28 in FIG. 7) which is incorporated into the main housing and further defines part of the rigid housing support structure located proximate a living hinge 30 established between a subset well portion 32 forming an integral part of the main housing body defining the fuel filler pocket and a fold-over portion 34 which is connected to the subset well portion by the living hinge 30.

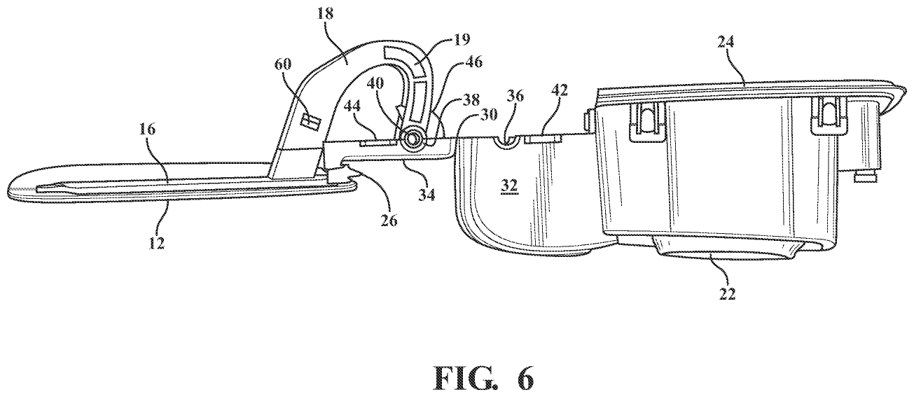

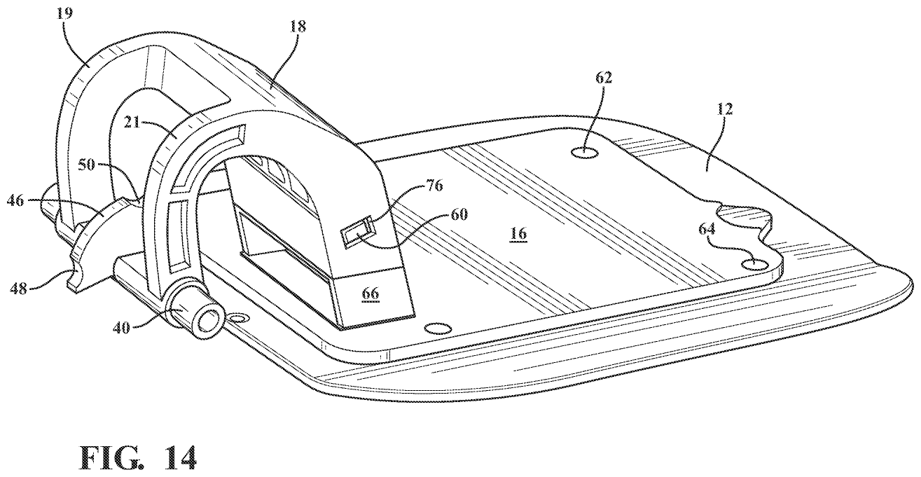

As shown in each of FIGS. 6-9, pivot support recesses are defined in the main housing for supporting a crosswise pivot pin of the hinge 18, these shown by semi-circular seating locations at 36 integrated into the subset well portion 32 of the main body, and which are opposed by semi-circular seating locations at 38 integrated into the living hinge separated fold-over portion 34. As further shown, the arcuate extending hinge portion 18 includes a width wise extending end pin 40 (see also as best shown in FIG. 14 et seq.) which is captured between the folded and affixed opposing pairs of pivotal support recesses 36/38. The pairs of semicircular support recesses 36/38 are further configured in opposing edge surfaces (see at 41 in FIG. 7) of the housing portions 32/34 so that pivoting engagement of the folder over portion 34 results in the capture of the width extending pin 40 therebetween for rotatably supporting the hinge bracket portion 18.

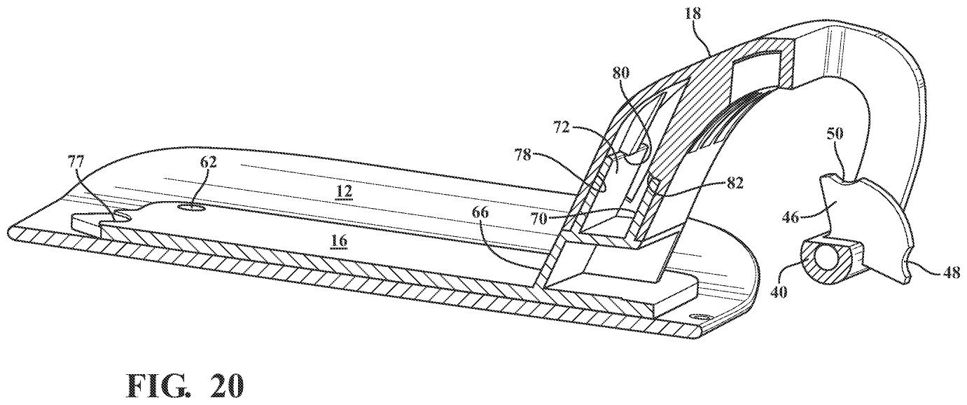

As further shown in FIGS. 6-9, pairs of tabs, at 42 and 44, are configured in the housing subset portions 32 and hingedly attached fold-over portion 34, these at locations proximate the pin capture recesses 36 and 38 so that, upon folding the portion 34 in engagement with the subset portion 32, the tabs 42/44 are also in alignment for receiving fasteners (not shown) through apertures defined therein (see as best shown in FIG. 1) in order to engage the hosing in the closed position. As further shown in FIGS. 6-7, the second piece 18 of the hinge further includes a dovetail shaped cam portion 46 (see again FIGS. 6-7) which biases against the cam roller tensioner 28 during rotation of the door 12 between the opening and closing positions. As best shown in FIG. 20, the dovetail cam portion 46 includes a pair of concave recess locations 48 and 50 which interact with the cam roller tensioner 28 to define respective fuel door open and closed positions relative to the fuel filler pocket housing.

Referring to FIG. 2, a rotated and rear looking perspective is shown of the fuel filler pocket assembly of FIG. 1 depicting the two shot hard/soft material construction of the assembly, this in combination with an integrated composite thermoplastic spring 52 embedded beneath the cam roller tensioner 28 within the hinge receiving subset portion 32 of the main filler pocket housing 20 for providing a degree of biasing accommodation to the filler housing body during the opening and closing motion of the hinge attached door, as translated through the dovetail cam portion 46 (see also as shown in FIG. 14) and the concave seating (open/close) recesses 48/50.

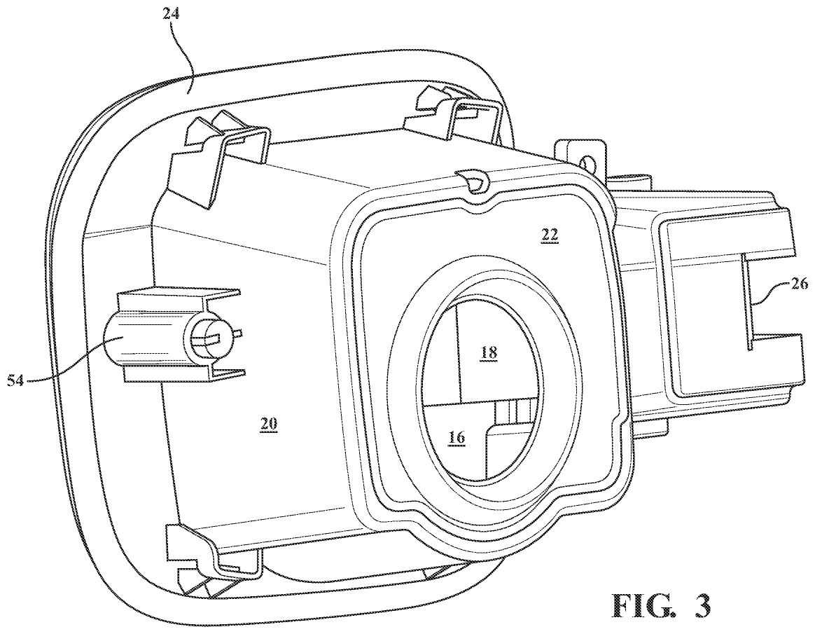

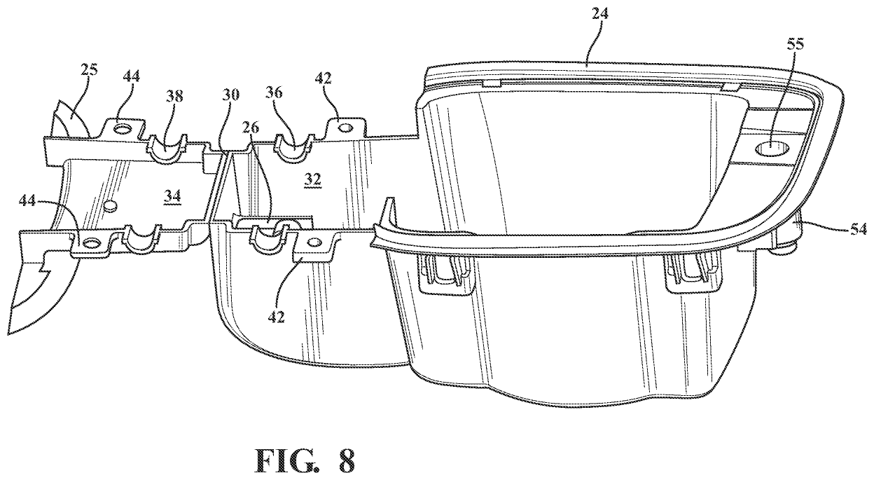

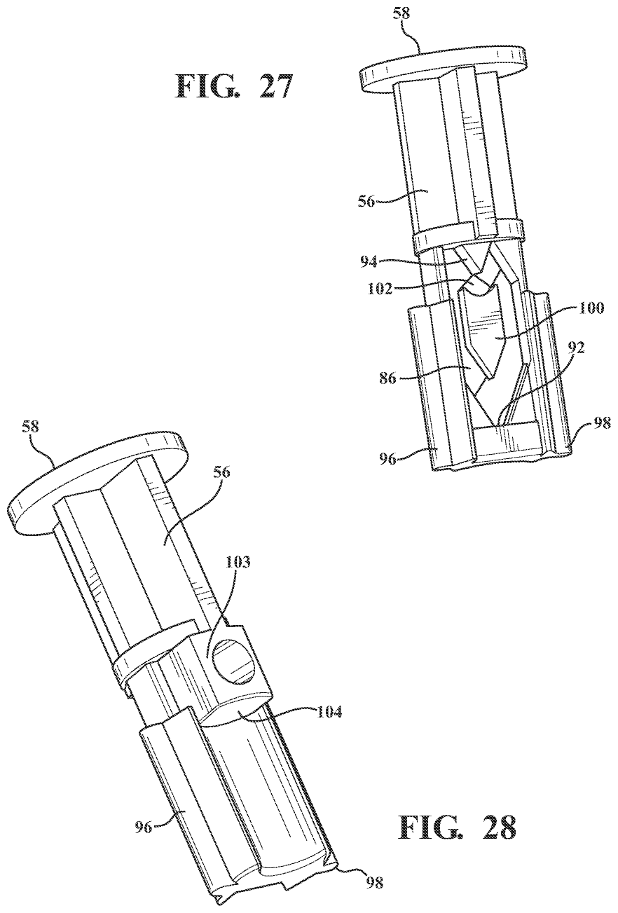

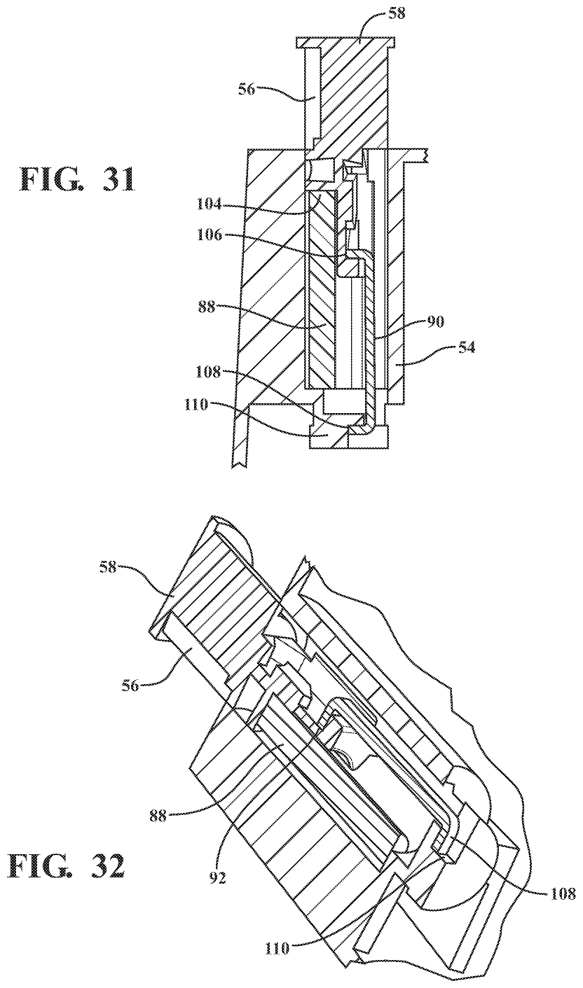

FIG. 3 is a further partially rotated rear side view of FIG. 2 and depicting a subset receiving pocket housing 54 which is configured into the first shot formation of the rigid housing 20. As best shown in FIG. 8, the subset pocket housing includes an open recess 55 for seating a door actuator 56 (more detailed reference to which being had in reference to FIGS. 27-34), and which is displaced between opened (upper displaced) and closed (lower retracted) positions. The actuator 56 includes, at an upper end, a flattened upper end face or lip edge 58 which interfaces with the underside of the pivotally mounted fuel door 12, this upon the user pressing the door against the flattened upper end profile face of the actuator and causing it to displace a specified distance owing to its mounting geometry (FIGS. 31-34) within the subset pocket housing 54.

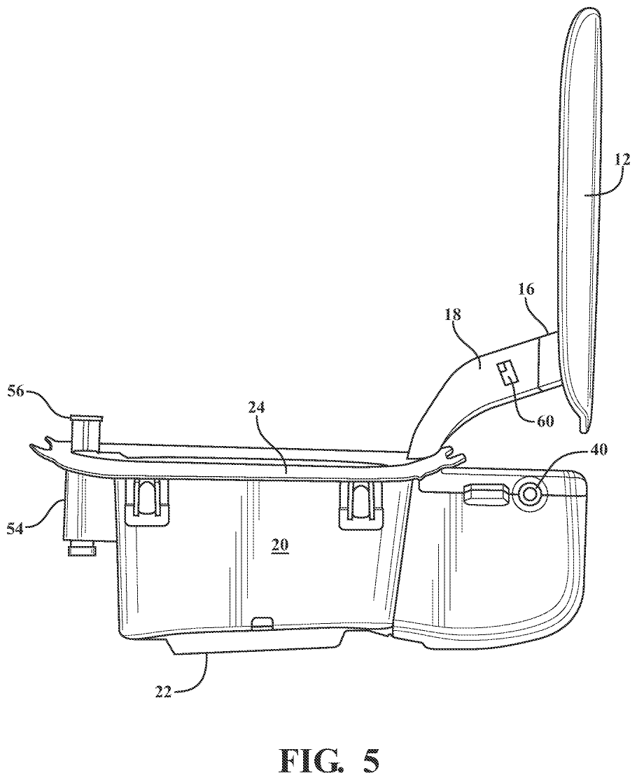

FIG. 4 is a forward looking perspective similar to FIG. 1 and depicting the two piece (16/18) molded hinge subassembly with the pivotally supported door 12 in the open position to revel the pocket shaped main housing interior 14 of the fuel filler pocket. Again shown is the door actuator molded component 56 seated within the recessed pocket 54 within a forward surface lip 57 of the fuel housing. FIG. 5 is a further rotated and side plan view of the assembly in FIG. 4 and depicting the molded door actuator component 56 with a rod shaped body from another angle in combination with a disengagement tab 60 associated with the first hinge part 16 and seating within an aligning window in the second hinge part 18 for enabling removal of the door 12 and first part 16 of the two piece hinge from the hinged supporting second portion 18 of the overall assembly.

FIG. 6 is a 180° rotated view of FIG. 5 and depicting the living hinge 30 separating the pivotal door hinge supporting tabs 44 associated with the fold-over sandwiching portion 34, along with the aligning tabs 42 configured into the rigid subset hinge receiving portion 32 of the main fuel filler pocket housing 14, and again shown in the opened position. FIG. 7 is a 90° rotated view and downward looking pre-assembly plan view of the fuel filler pocket also depicted in FIG. 6 and again showing each of the two shot molded hinge to fuel door attachment, cam roller tensioner 28 and two shot fuel housing (this again including both rigid 20 and soft 22, 24, 25 and 26 portions) of the present assembly. The □U□ shaped configuration of the soft portion 26 is configured proximate the hinge location and surrounding the cam roller tensioner 28, this again in order to provide a desired degree of bias give or play of the dovetail configuration 46 projecting from the hinge 40 acting upon the cam roller tensioner between the open and closed positions.

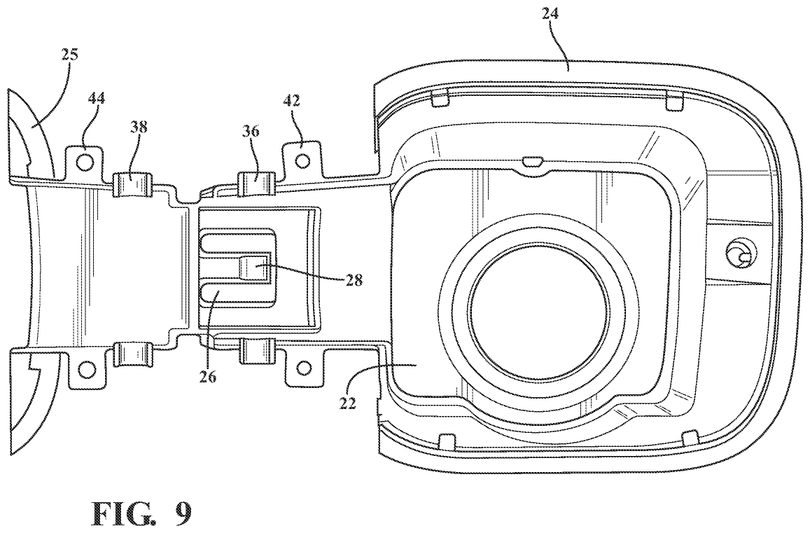

FIG. 8 is an intermediate rotated view between those shown in FIGS. 6-7 and better depicting the living hinge 30 configured into the fuel filler pocket housing, this again located for separating the pivotal door hinge supporting and fold-over portion 34 from the sandwiching and subset receiving portion 32 of the main fuel filler pocket housing 14, and as shown in the opened position. FIG. 9 is an enlarged and partial plan view of FIG. 7 and better showing the cam roller tensioner feature 28 integrated into the rigid portion of the main fuel filler pocket housing and which receives the pivot pin 40 (again FIG. 7) of the hinge bracket prior to sandwiched engagement of the pivoting door supporting portion, this again in order to define both an opening and closing direction resistance and to hold the fuel door in either of the closed or opened positions.

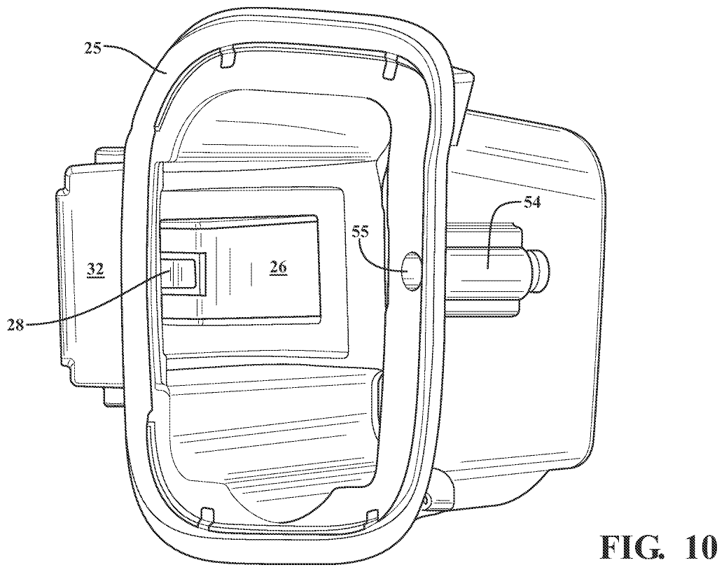

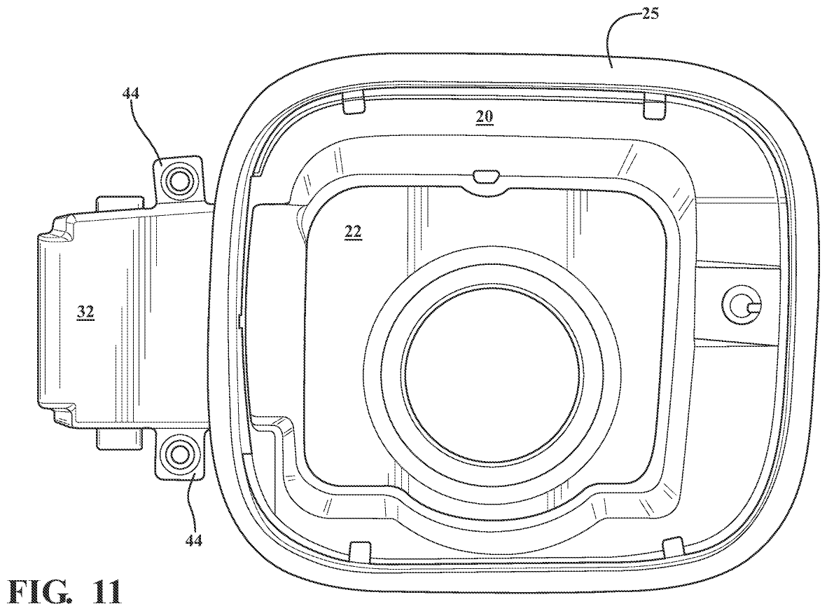

FIG. 10 is a further rotated and front isometric view with the attachable hinge and door removed and depicting the cam roller tensioner 28 and seating pocket 55 defined in the main pocket housing for supporting the door actuating molding component (again at 56 in FIG. 27 et seq. but not shown in this illustration). FIG. 11 is an enlarged and rotated forward view of the main two shot housing depicted in FIG. 10 for the fuel filler pocket housing, again with the fuel door 12 and attaching (two piece 16/18) hinge removed.

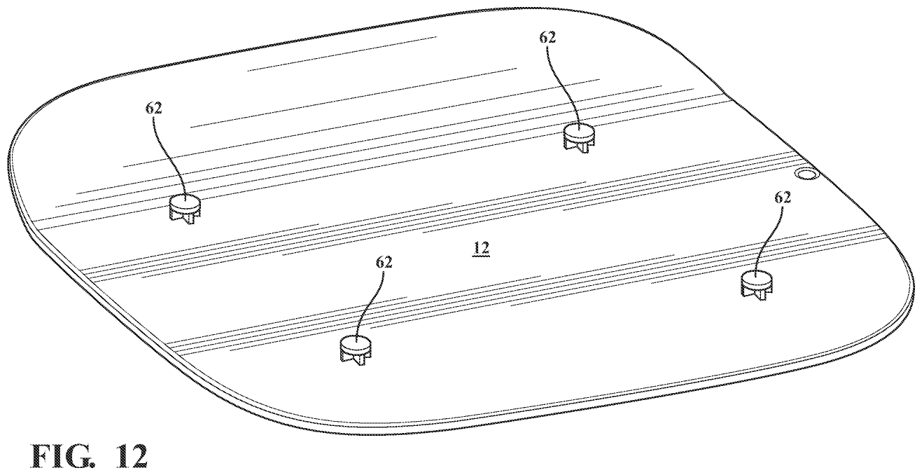

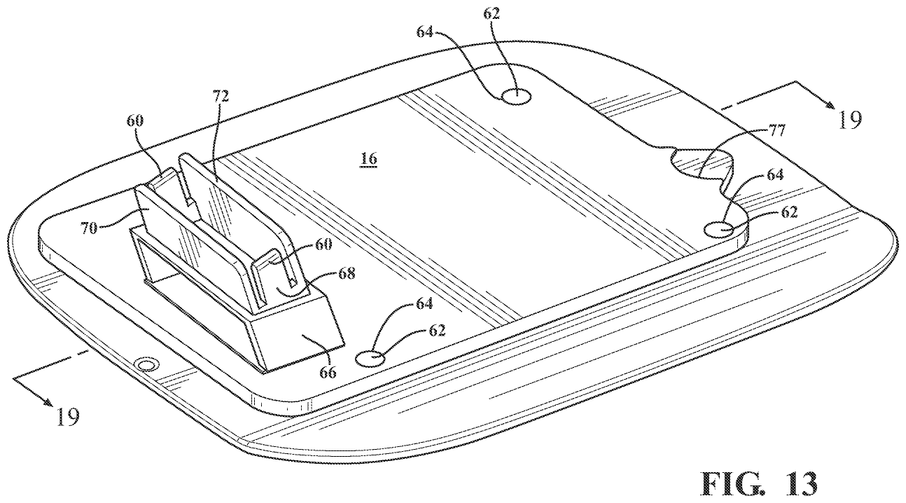

Proceeding to FIG. 12, illustrated is an iso/perspective view of the molded fuel door portion 12 by itself and which exhibits a plurality of attachment tabs 62 which can be configured as part of the injection molded rigid material. The tabs 62 are formed upon the underside of the molded door and permit the door to be either molded directly with the corresponding planar support surface of the first removable portion 16 of the hinge bracket or, as shown with reference to succeeding FIG. 13, adapting the door 12 to being snap-engaged through resistance engaging apertures 64 configured in the bracket support first hinge portion 16.

FIG. 13 provides a succeeding view to FIG. 12 and showing the first molded hinge bracket portion 16 secured to the inside surface of the fuel door 12. Further depicted in FIG. 13 is an array of projecting portions integrated into and configured toward an end of the flattened planar hinge supporting portion 16 for receiving the hinge bracket portion 18. The projecting portions are depicted by a rectangular shaped platform 66, with a further array of planar portions extending upwardly from the platform 66 and including each of a pair of side projecting supports 68 (which terminate in the pair of engagement tabs 60), in addition to first 70 and second 72 elongated tabs extending in spaced apart fashion between the side tabs 60, these collectively defining a multi-sided and flex biasing engagement profile for engaging within an opposing open interior defined in the second molded hinge bracket portion 18 (this in turn being secured to the filler pocket housing 14 again via the molded hinge pin 40) and in order to secure the door to the filler pocket housing.

FIG. 14 is a succeeding view to FIG. 13 and depicts the first 16 and second 18 hinge bracket portions attached together, with the open rectangular configured end face of the hinge portion 18 aligning with and receiving the array of projections of the first hinge portion 16 in FIG. 13, and again depicting the laterally outwardly biased tabs 60 of the first hinge bracket portion 16 seating through receiving windows (see at 76) configured in side walls defining the open interior of the second hinge bracket 18, the second hinge bracket portion further again depicting the inner end configured hinge portion (widthwise extending pin 40) in turn integrating the wedge shaped detent component 46 with arcuate recesses 48/50 defining again both door open and closing positions in combination with acting upon the cam roller tensioner (previously at 28) and integrated composite spring 52. The second hinge portion 18 includes an arcuate profile (see split portions 19/21) to accommodate seating within the fuel filler pocket and subset hinge receiving portion 32.

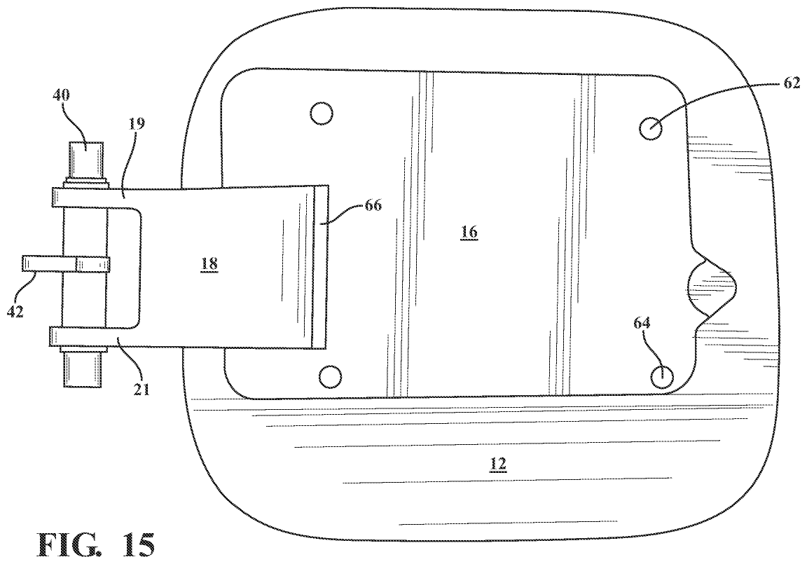

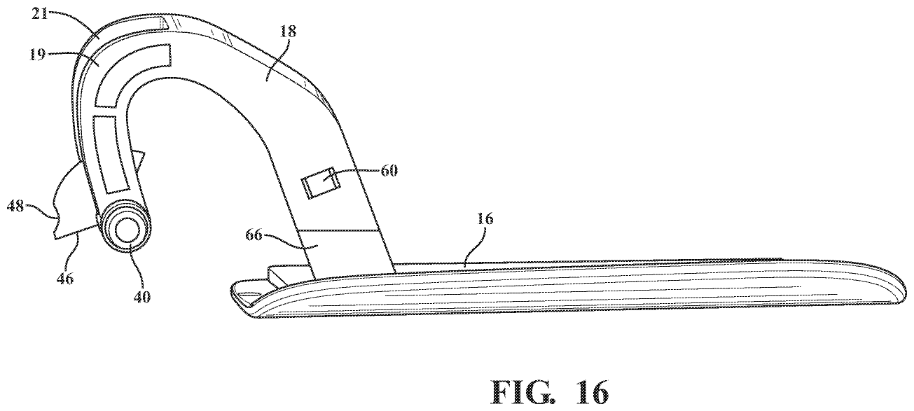

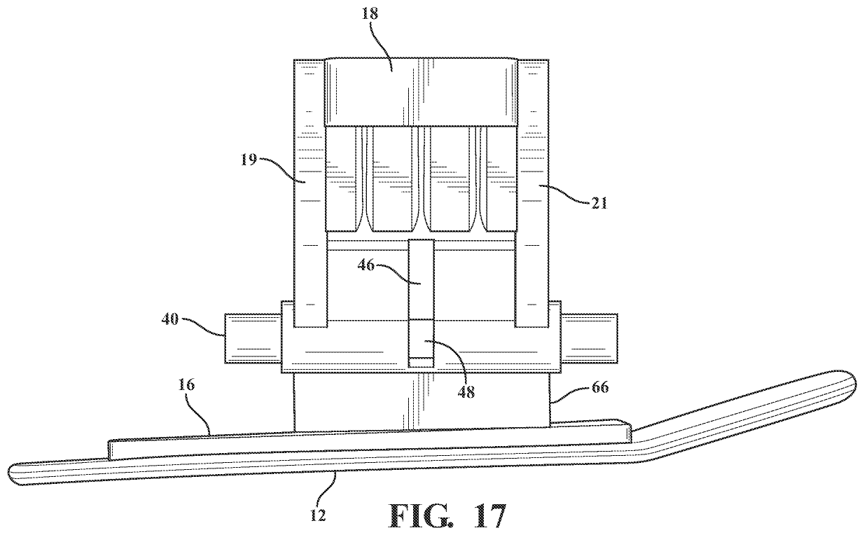

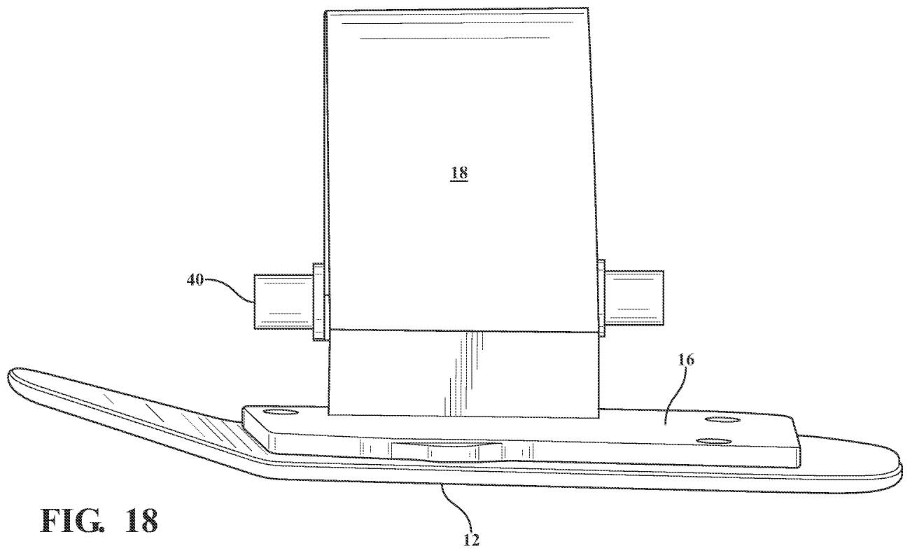

FIG. 15 is a rotated downward looking rear plan view of FIG. 14 and depicting the fuel filler pocket with molded two shot door along with assembled two piece hinge 16/18, with FIG. 16 further depicting a rotated side plan view similar to that shown in FIG. 14 from another angle. FIG. 17 presents a rotated and rearward looking plan view of the door and hinge assembly in FIG. 16 and better showing the shaping of the door 12, bracket and hinge portions 6/18 from a rearward looking direction. FIG. 18 is a 180° rotated front and showing the combination of the door 12, and two piece hinge 16/18 from a forward looking direction.

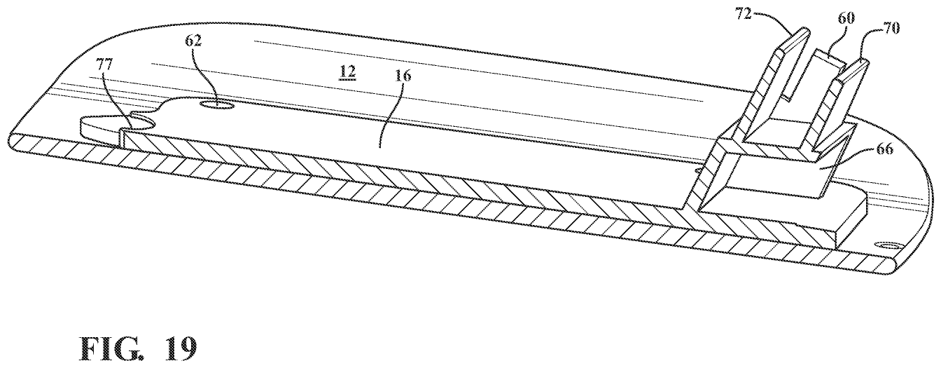

Proceeding to FIG. 19, presented is a combination cutaway taken along line 19-19 of FIG. 13 and rotated view of the door and first attachable or molded hinge portion and better depicting the profile array of projecting portions 60, 70, 72, including support pedestal 66, of the first hinge portion 16 which engage within the opposing open interior of the second molded hinge bracket portion 18 for mounting both the door and first molded hinge portion in a flexural snap fit resistive engaging fashion. Also depicted with the planar rear door attachment portion of the first bracket 16 is a semicircular shaped end feature 77.

FIG. 20 is a succeeding view to FIG. 19 and illustrating the interior inter-engagement profile established between the opposing engagement arrays of the first 16 and second 18 hinge defining portions of the two piece bracket. This includes a cutaway depiction of the interior rectangular end receiving profile (see at 78) of the second hinge portion 18 for receiving the opposing rectangular configured projection array (including biased side tabs 60 and elongated inter-extending tabs 70/72) in a biasing snap engaging fashion. The cutaway interior of the second hinge 18 further depicts interior configured shoulders 80/82 which define abutting end stop locations for the inserted tabs 70/72, these in combination with the tabs 60 projecting through the side windows 76 (FIG. 14) securely engaging the hinge portions 16/18 together in the manner previously described.

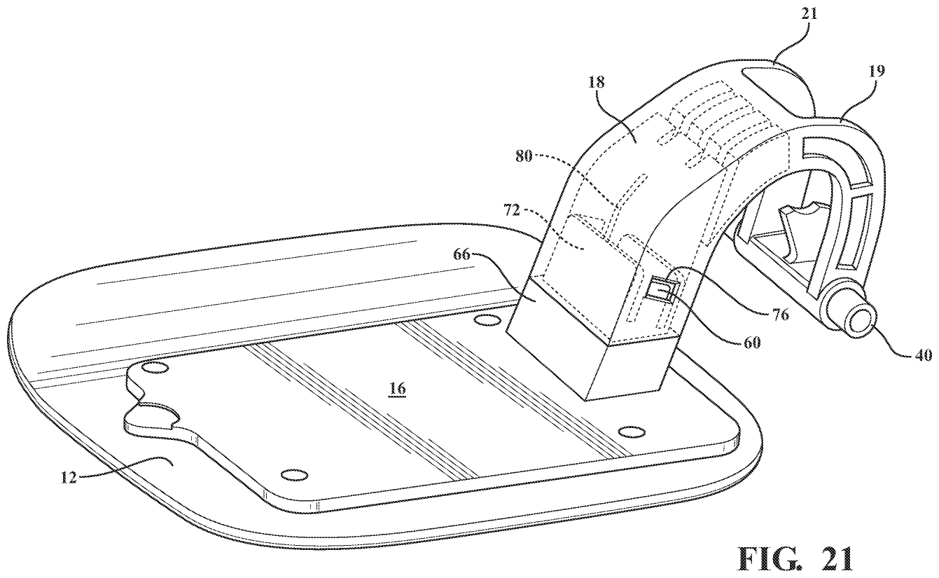

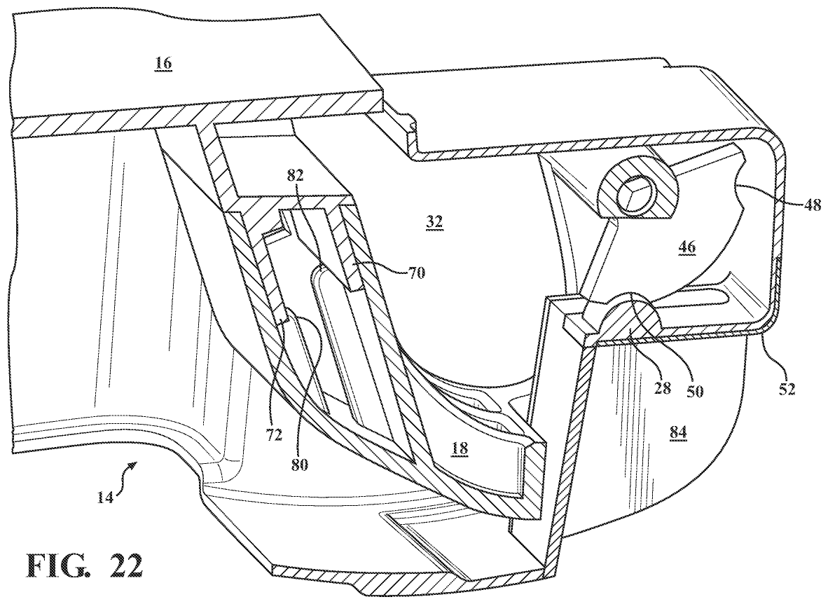

FIG. 21 is a substantially 180° rotated view of FIG. 14 and depicting the second attachable hinge bracket portion 18 in partial see through phantom fashion, and in order to better depict the inter-engagement of the first and second bracket portions. FIG. 22 is an enlarged and partial cutaway perspective depicting the mounting interface established between the arcuate and wedge shaped detent component 46 extending from the pin 40 of the hinge bracket 18 and in contact with the cam roller tensioner component 28 and composite (substantially □L□ shaped) spring 52 integrated into the filler pocket housing, specifically into lower adjoining surfaces of the subset portion 32, with the filler door (not shown) understood to be rotated to the closed position.

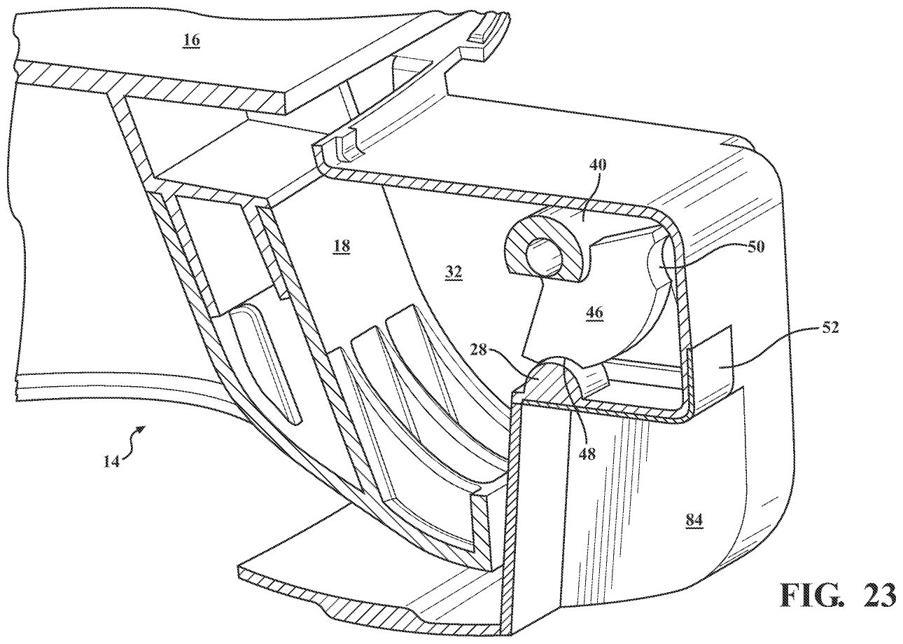

FIG. 23 is a partial rotated view of FIG. 22, again with the door in the closed position, and showing the protuberance 28 in the housing defining the cam roller tensioner along with depicting the integrated composite spring 52 from a different perspective. FIG. 24 is a further rotated and different cutaway depiction of an un-sectioned hinge mounting portion (pin 40) with detent component 46 in combination with the cam roller tensioner protuberance 28 and related interior support structure associated with the filler pocket housing. As further shown, the split arcuate portions 19/21 of the hinge component 18 extends from a common rear surface 23 and so that the split portions straddle an interior support portion 84 located within the rigid main housing 20 at a bottom rear of the hinge receiving subsection 32. The support portion 84 supports the cam tensioner protuberance 28, the composite spring 52 and the soft shot injection thermoplastic portion 26 as further shown.

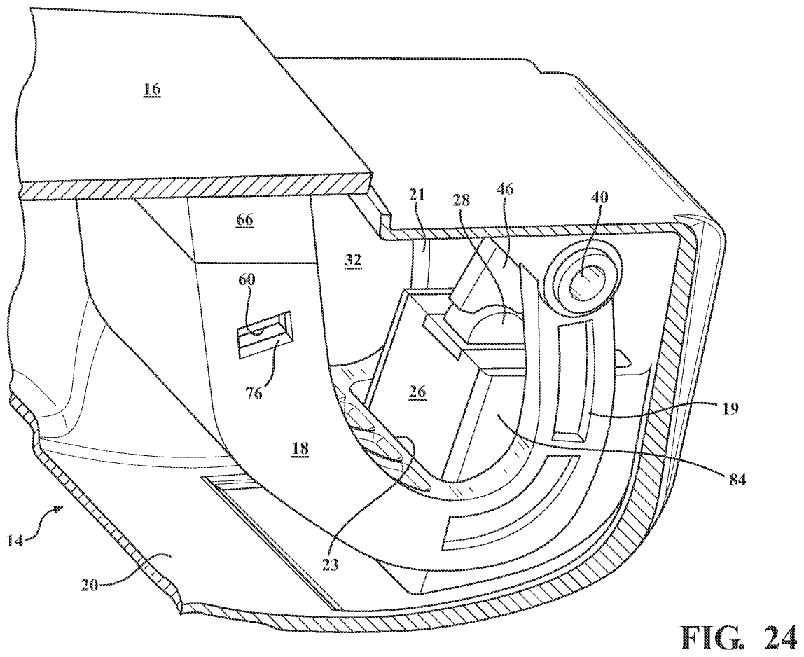

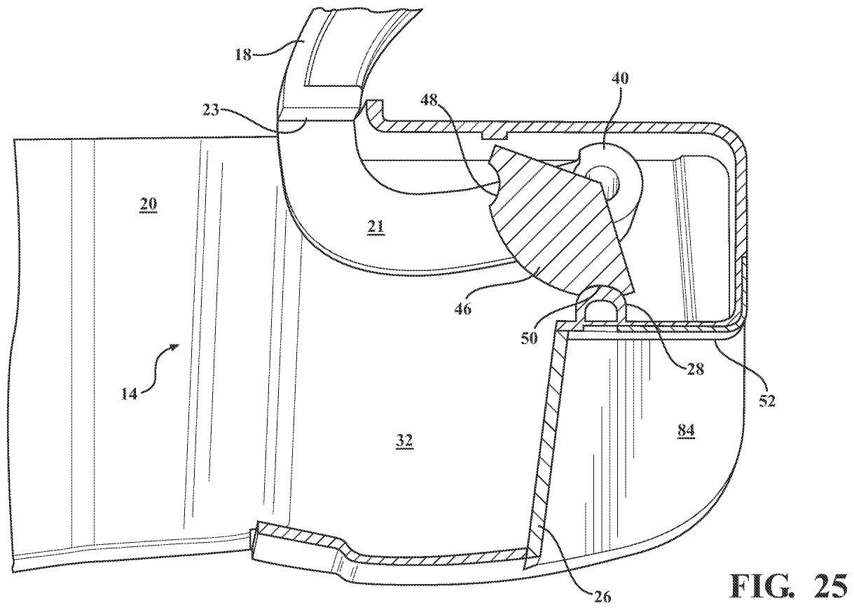

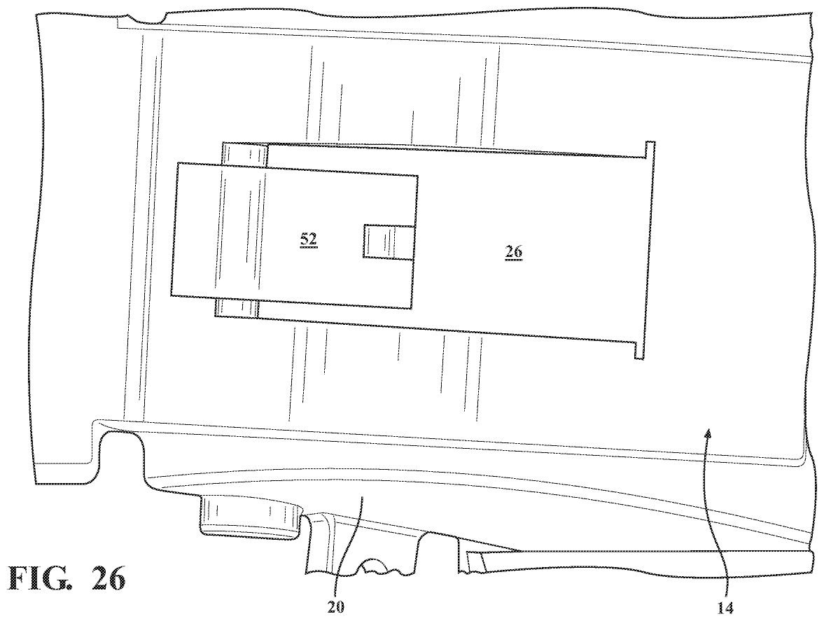

With reference to FIG. 25, a side plan view similar to FIG. 22 is shown with the hinge and fuel door (not shown) pivoted to an open position and corresponding with the second 50 of the arcuate recess locations of the detent cam component 46 of the hinge pin 40 rotating into a resistive seating engagement with the protuberance 28 component of the cam roller tensioner. FIG. 26 further shows an enlarged partial illustration of the composite thermoplastic spring 52, also depicted in FIG. 2, which is integrated into the fuel filler pocket housing 14 and which can include, without limitation, any combination of fabricated or molded components including a thermoplastic material with oriented strand fibers and further not limited to fiberglass, carbon fiber or Kevlar® materials. The cam spring 52 as previously described is shown have a generally □L□ curvature or shape and can be embedded within the rigid housing subset portion 32 in proximity to the interior support location 84, such as according to the injection molding techniques employed, and so that the spring is located in proximity to the cam protuberance 28 for providing the necessary biasing effect to the cam detent 46 as the pin 40 rotates the detent between the inwardly notched open 48 and closed 50 detent positions, and further such that the closure force and displacement speed are controlled by the cam geometry for effectuation holding the door and bracket in either of the closed or opened positions.

Proceeding to FIG. 27, an illustration is again provided of the door actuator molded component forming the push-push mechanism and which again includes a generally elongated and cylindrical shaped component including an upper stem, again shown at 56, which is received within the aperture 55 leading into the recess pocket 54 of the main housing body. The aperture 55 is again formed within the forward interior receiving lip (see again at 57 in FIG. 4) of the fuel filler housing, and at an end opposite the hinge pivotal support location.

As further shown in FIG. 27, the component 56 further incorporates an arrangement of the upwardly projecting button portion (see again flattened upper end surface 58) in combination with a pseudo diamond shaped travel profile or pathway 86 which is formed within a lower region of the component 56, and along with an elongated compression pad 88 (see FIG. 31) supported within the recessed interior of the receiving passageway 55 for exerting a continued upward bias against the button portion during up/down travel of the component 56 relative an angled end of an engaging tang 90 (see again FIG. 31) as directed by the integrated travel profile 86 configured within the door actuator component 56.

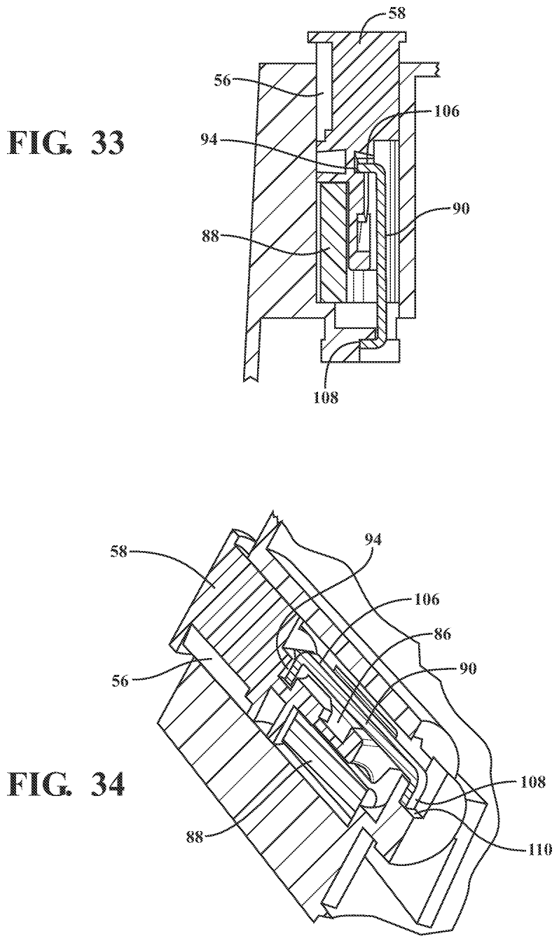

Referring again to FIG. 27, the diamond shaped travel passageway 86 includes both a bottom engaging position 92 (see also FIG. 32) corresponding to an upwardly displaced position of the actuator component 56, as well as a top engaging position 94 of the upper surface 58 of the component 58 (see also FIG. 33) corresponding to a retracted position of the component. The lower portion of the component 56 further includes a pair of seating/guiding projections 96 and 98 which align with seating locations in the recess defined pocket 55 defined in the filler housing body and accessible through the upper lip 57 (see again FIG. 4). The diamond passageway is further defined by each of outer and inner guiding portions, this further including a central-most projection 100 with a concave upper profile 102 which opposes a triangular shaped profile associated with the top engaging position 94 and for guiding the push-push action of the component between the extended and retracted positions of FIGS. 32-33.

FIG. 28 is a rotated view of the molded component of FIG. 27 and depicting a lateral projection 103 for positioning and seating the component 56 within the receiving location defined in the filler pocket housing (as best previously shown in FIGS. 9-11). The lateral projection further defines an underside surface 104 which, as further shown in FIGS. 31-34, contacts and biases he upper end of the elongated compression pad 88.

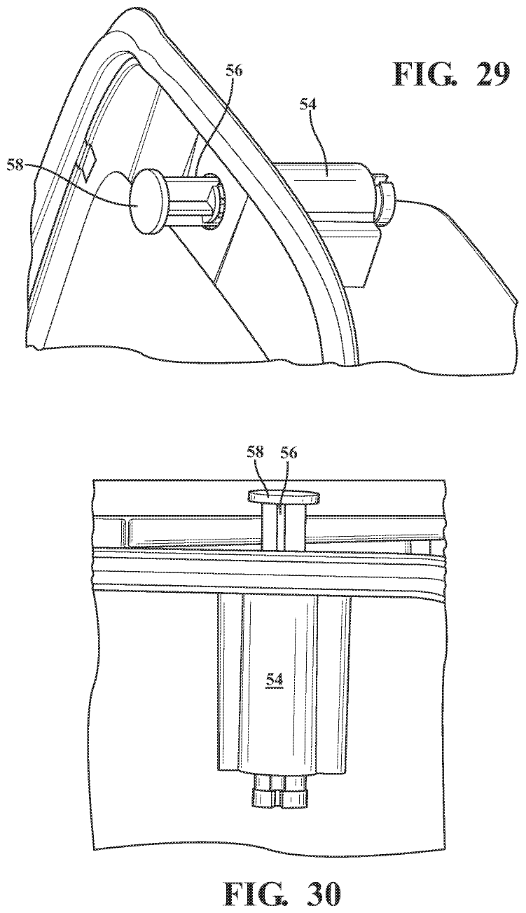

FIG. 29 again provides a depiction of the door actuator component 56 supported within the receiving location of the filler pocket housing and shown in the extended (upwardly projecting) position, with FIG. 30 depicting a rotated end plan view of FIG. 29 and again depicting the component in the extended position.

FIG. 31 is a plan cutaway illustration of the door actuator component 56 and receiving pocket and depicting the elongated engagement tang 90 includes each of an upper angled end 106 engaging within the diamond passageway 86 of the component in combination with a lower angled end 108 which is anchored against a base location 110 of the receiving pocket 54 integrated into the structure of the fuel filler housing (see also as shown in FIG. 32). The upper angled end 106 of the tang 90 travels within the diamond shaped travel profile of the component associated with the extended position of FIGS. 29-30, with the exerted bias from the recess interior supported compression pad 88 providing a upward continuous upward bias against the upper end button 58 of the push-push component 56 during the up/down travel of the engaging tang 90 as directed by the integrated travel profile.

FIG. 32 provides a rotated perspective of FIG. 31 and again showing the interior tang 90 and compression pad 88 components from another angle, with FIG. 33 depicting an illustration similar to FIG. 31 with the door actuator component 56 downwardly displaced, concurrent with pressing engagement of the fuel door 12, to the inner closed position and concurrent with the tang 90 traveling within the diamond shaped travel profile 86 to an upper corner location (again corresponding to top engaging position 94). FIG. 34 is an illustration similar to FIG. 32 depicting the component and tang in the open position of FIG. 33.

The biasing effect of the push-push component 56 works in combination with the cam detent portion 46 of the hinge pin 40 in order to influence the fuel door 12 to the open position. This occurs following the door 12 in the closed position being pushed/depressed against the top flat surface 58 of the component in the closed position of FIG. 33) so that the guiding travel of the tang end 106 is influenced upwardly within the guiding passageway 86 (in response to the upward influence of the compression pad 88, thereby causing the component 56 to travel upwardly to the biased upwardly to the open position shown in FIGS. 5 and 32, concurrent with the opening fuel door acting upon the detent cam 46 during travel from the closed position concave recess 50 to the open position concave recess 48 in contact with the cam tensioner protuberance 28. The action of the push-push component is reversed upon subsequently reclosing the door 12 to depress the actuator component 56 back to the closed position (FIGS. 23-24 and 33-34).

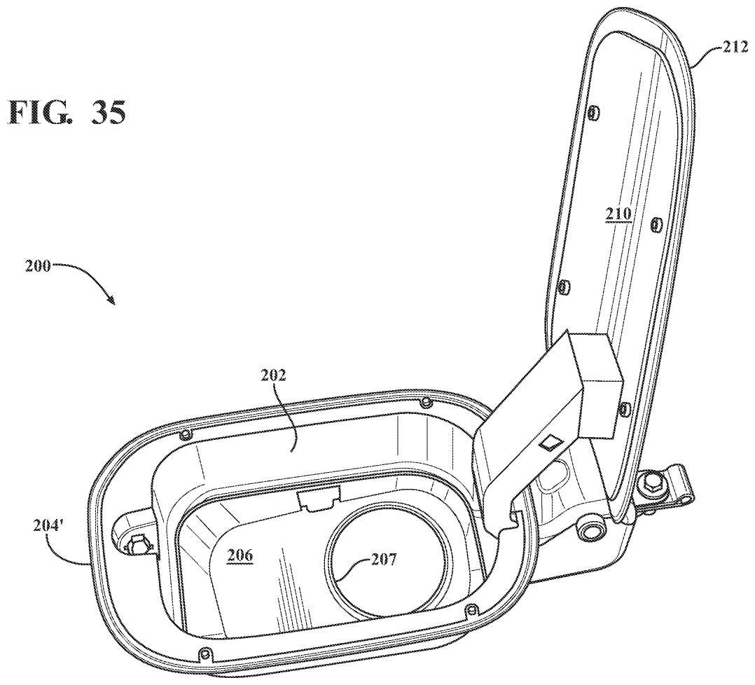

Referring now to FIG. 35, a perspective illustration is generally shown at 200 of a fuel filler pocket and door assembly according to a second embodiment of the present invention. The assembly 200 repeats many of the same features of the assembly 10 of FIGS. 1-34 and provides an automotive assembly of components used to manage the fuel filler tube and cap on the exterior skin of the vehicle. As described previously in reference to the first embodiment 10, the assembly incorporates several design and material innovations to provide improved performance at a reduced cost. The door is further removable from the pivoting bracket sub-assembly in order to permit for painting and reinstallation, such as in order to provide for better color matching giving the material differences between the fuel door (typically a polymer composite) and that of the surrounding vehicle skin (typically metal).

The assembly 200 in FIG. 35 et seq. again includes a fuel filler pocket dual shot housing which includes each of first shot 202 (usually harder) and second shot 204/206 (usually but not necessarily softer) thermoplastic materials, not limited to those previously described in reference to the first embodiment. The lowermost pocket defining material shot 206 can further again include an inner defining rim 207 for receiving an end of a fuel filler tube (not shown).

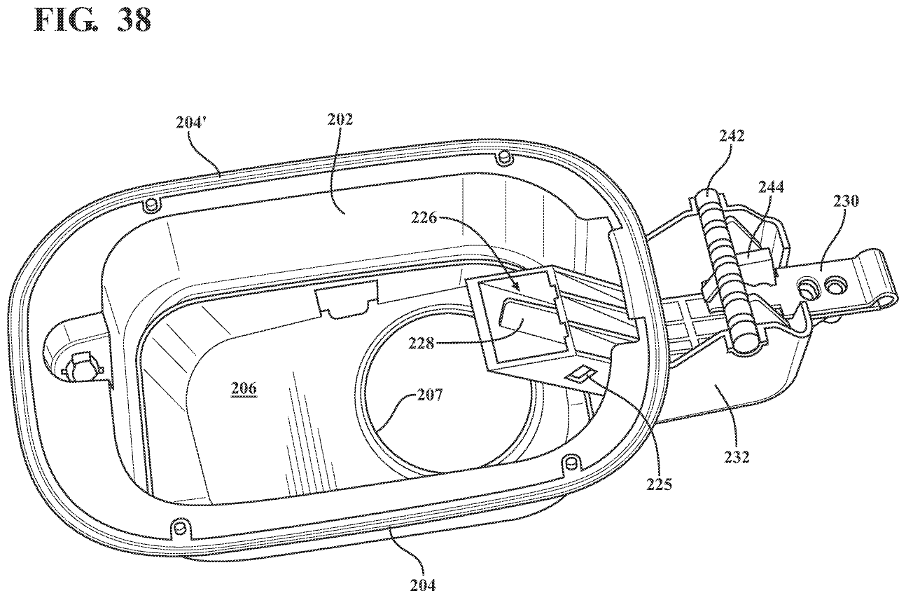

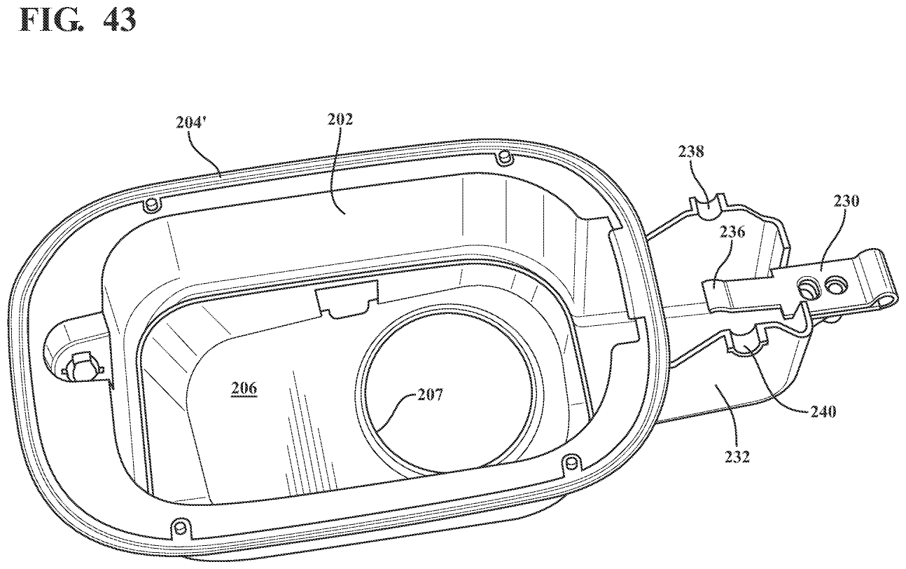

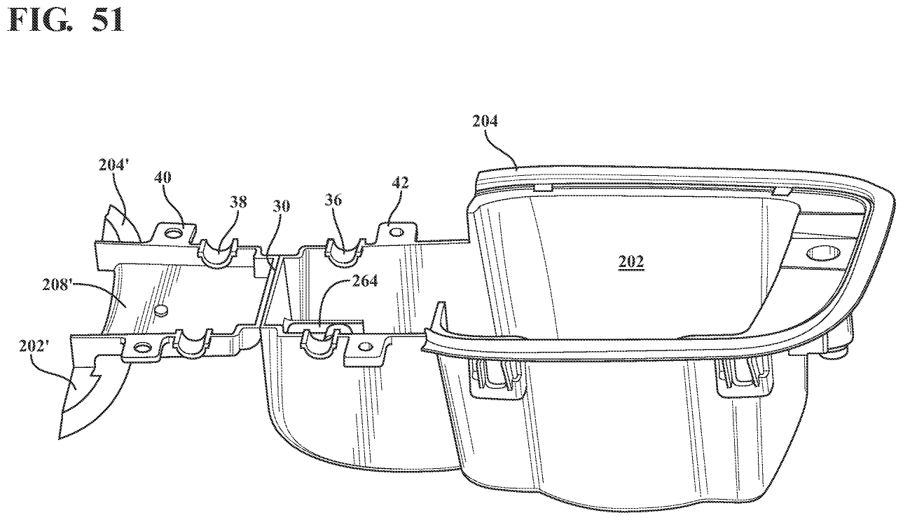

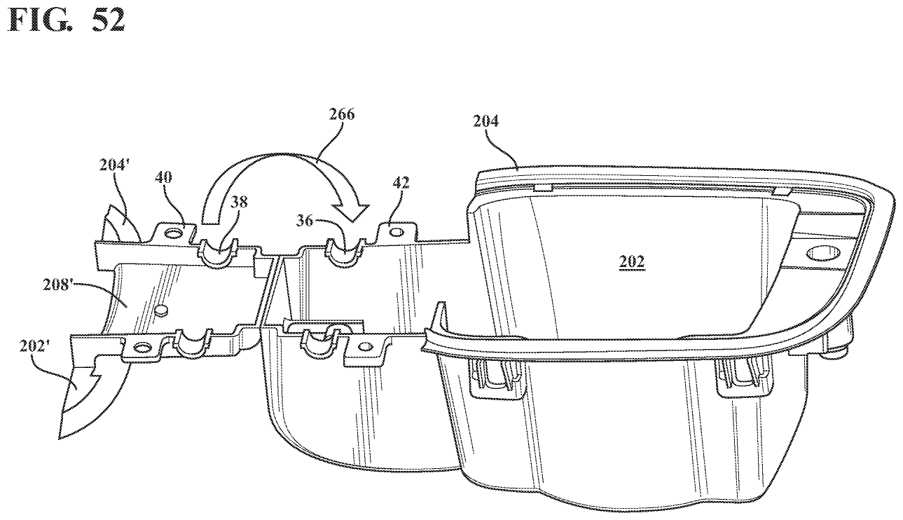

As further shown in FIGS. 51-52, a similar configuration to that previously depicted in FIGS. 7-9 of the first embodiment is illustrated and can include an attachment or cover portion 208□ (also termed a housing door and as shown in FIGS. 38-44) which provides pivotal support for the hinge bracket. The cover can be substituted by a living hinge pivot pin retainer system portion of the housing (see FIGS. 51-52) as will be further described. As will also be described with reference to FIGS. 51-52 is a further second shot perimeter material 204U (see also as shown in FIG. 43) and which seats against a perimeter of a further portion of the first shot material (see 202U).

With reference again to FIG. 35 et. seq., the door can also include a main body (first shot) portion 210 with a second shot injected molded outer covering or trim portion 212 (typically softer than the first shot rigid housing) which can again be formed in a two step injection molding process utilizing any of the array of thermoplastic resin materials previously described. Attachment of the outer trim portion 212 to the main body 210 can also be obtained through cohesive or mechanical bonding within either of a rotary two shot or pick and place injection molding operation.

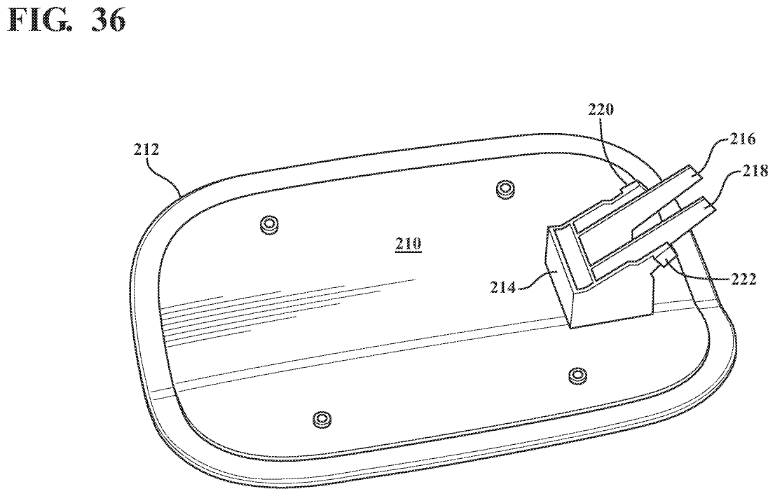

Additionally, and as described in FIG. 36, the door of FIG. 35 is depicted removed from the assembly and including a first component of a two piece pivoting bracket, such as which can be produced according to a rotary two shot molding process for molding a bracket supporting portion directly to the inside of the door. The first bracket portion as shown includes a pedestal superstructure portion 214 secured or integrally molded to an inner and edge proximate location of the door main body 210. Engagement fingers (also termed molded in snap features) extend from the pedestal superstructure 214 at an angle and include an inner pair of fingers 216/218 along with an outer pair of biasing side tab fingers 220/222.

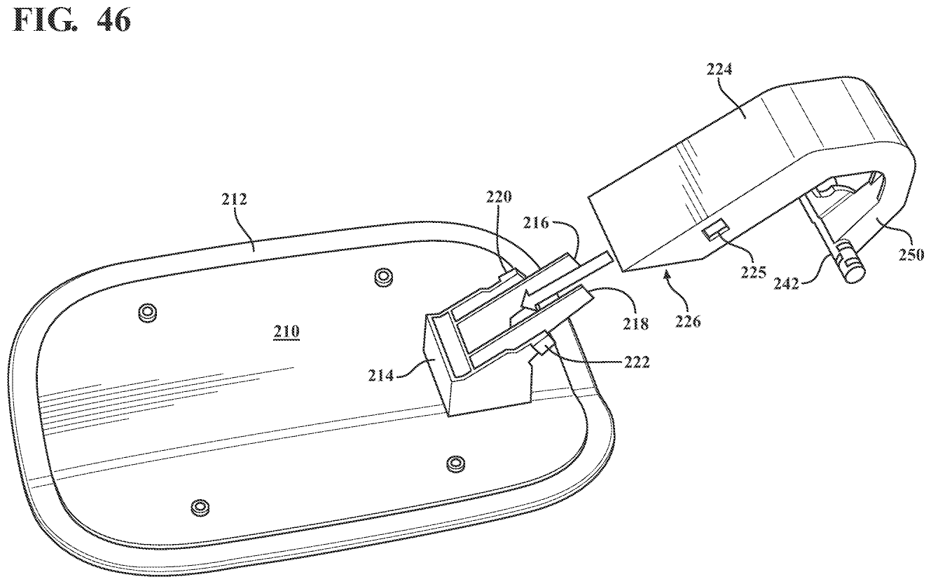

With further reference to FIG. 46, the two piece hinge is shown in exploded fashion to reveal a second hinge component 224 having a snap receptacle (see at 226) associated therewith and which is arrayed relative to the molded in snap features (inner and outer pairs of spaced fingers 216/218 and tab fingers 220/222) of the door inside support portion. A pair of side windows (also termed snap receptacle features) are shown at 225 in FIG. 38 and are configured within the side of the second hinge component 224 for ensuring alignment and correct displacing resistive snap engagement of the outer side pair of tabs 220/222 integrated into the door supported in-molded hinge component.

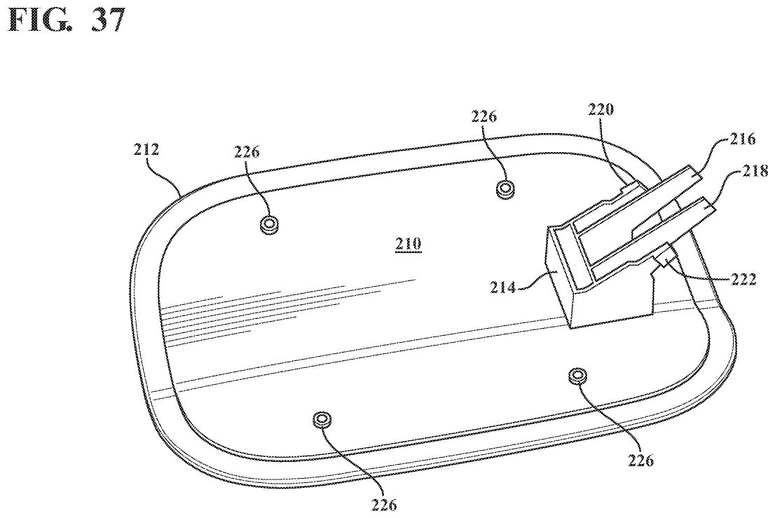

FIG. 37 is a substantial repeat of FIG. 36 and depicting the first 210 and second 212 shot thermoplastic resin portions, this in combination with a combination of geometrical in mold door fastening tabs, see at 226, associated with the first shot molding operation. FIG. 38 is another illustration of the filter pocket housing and hinge assembly, with the door removed, and showing the open rectangular receptacle 226 in the second hinge component 224 for receiving the inserting locating features/fingers 216-222 in order to engage the door to the hinge bracket.

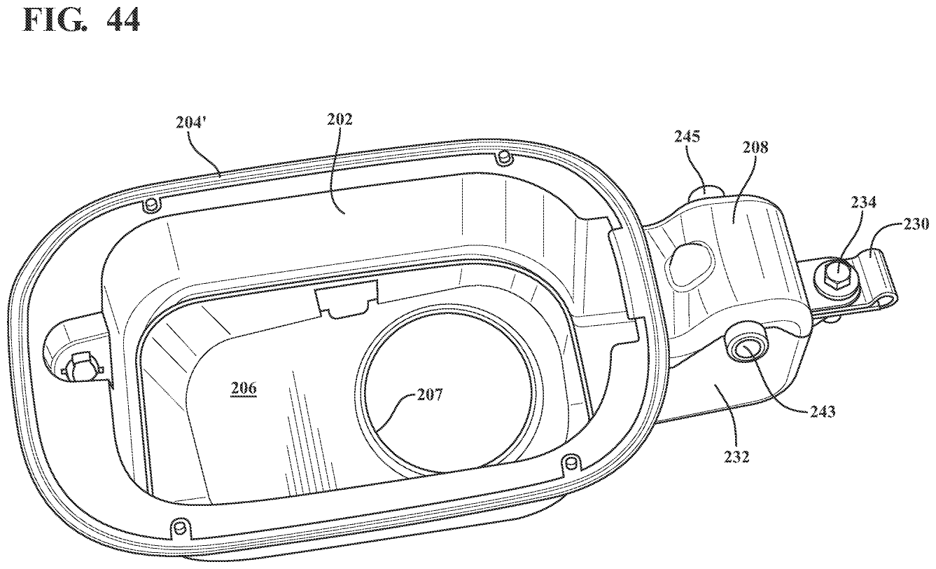

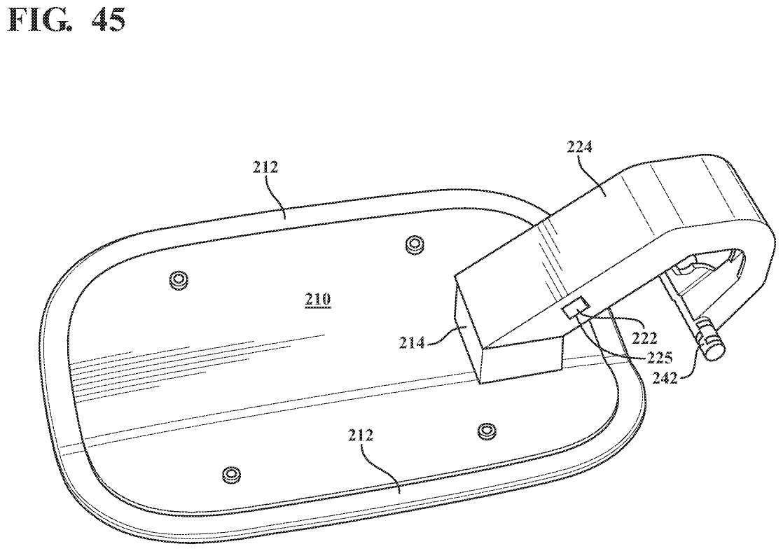

Additional to side windows 225 configured in the second hinge component (hinge bracket 224), also depicted in FIG. 38 are inner guiding ramps 228 which co-act with the inserting alignment features/fingers 216/218 to align the side tab features 220/222 with the opposing side windows 225 in the hinge bracket 224. Also shown in FIG. 38, is a composite spring 230 integrated into a hinge receiving subset portion 232 configured with the molded rigid housing 202. The spring 230 exhibits an elongated strap shape which is secured to an end of the subset housing portion 232 (see attachment bolt 234 in FIG. 44) for attaching the outer pivot location cover 208.

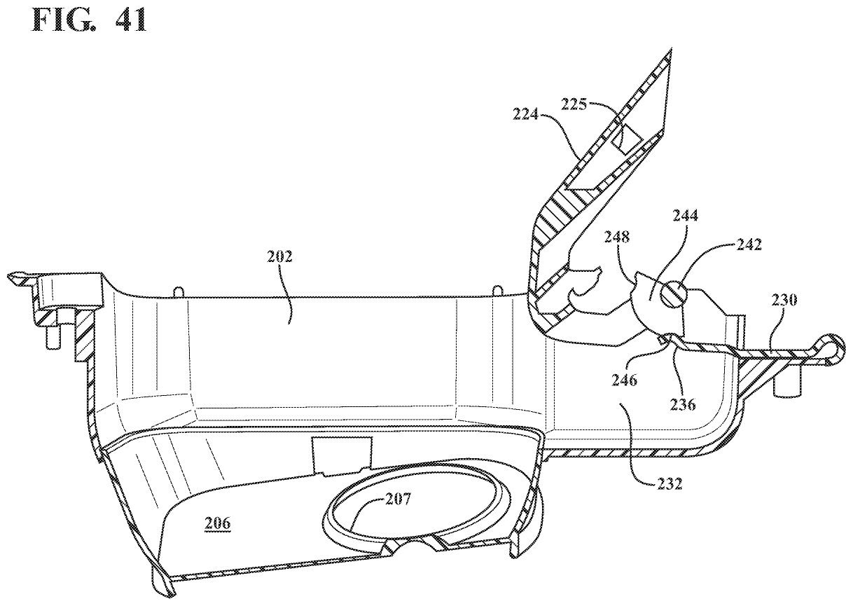

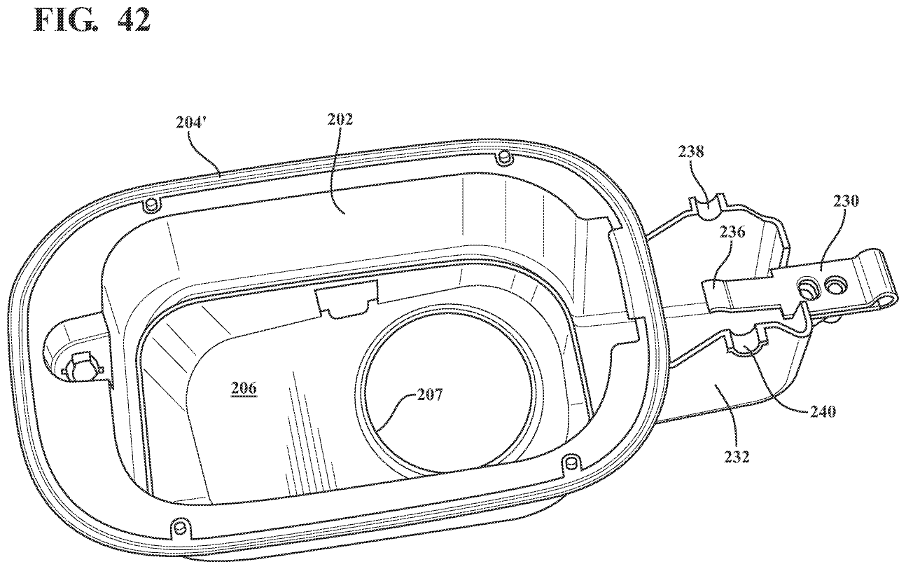

As further shown in FIGS. 41-43, the composite spring 230 includes an arcuately configured inner end defining a small protuberance 236 which, as will be further described, is positioned between a pair of semi-circular recesses 238/240 (FIGS. 42-43) defined in an upper rim edge of the subset hinge seating housing portion 232 (these opposed by lower semi-circular recesses 243/245 in the cover 208 as shown in FIG. 44 for capturing the width extending pivot pin 242 therebetween. A tapered cam and detent system is also provided for rotating against either of the in-molded or installed composite spring 230 and includes a widthwise extending pin 242 defined at an inner end of the hinge bracket 224.

As with the first embodiment, a detent cam feature 244 is configured centrally with the width extending pin 242 and includes a wedge shaped component having a pair of cam detents (concave recesses) 246 and 248 configured within the wedge component opposing the composite spring end protuberance 236 and corresponding with open and closed pivoting locations of the fuel door (see as best shown in FIG. 41). In operation, and as with the first disclosed embodiment, the cam spring mechanism provides for the door opening and closing cycle through the tapered cam and detent system rotating against the in-molded or installed composite spring 230.

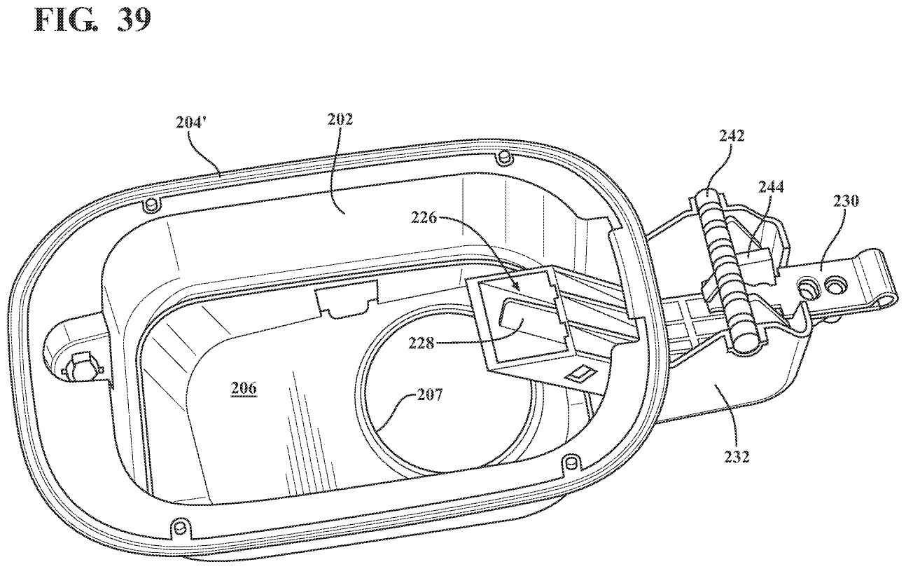

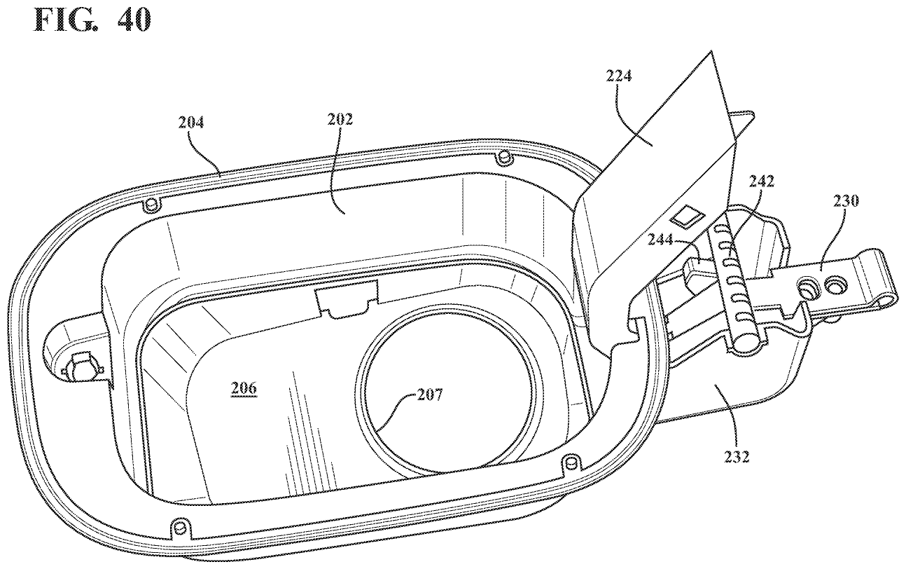

FIG. 39 is a substantial repeat of FIG. 38 and depicts the base component of the hinge structure in the closed position along with the cam feature 244 and composite spring 230 components. FIG. 40 is a succeeding view to FIG. 39 and showing the door supporting hinge structure 224 (without the door and in-molded hinge support component illustrate) rotated to an open position as depicted in FIG. 35, this in combination with designating the multi-shot resin material portions as well as again depicting the receiving location in the filler pocket housing for supporting the door actuating component.

Proceeding to FIG. 41 a further side rotated view of FIG. 40 depicts, from another angle, each of the cam feature 244 with cam detents 246/248 and composite spring 230 components. FIGS. 42-43 provide a pair of illustrations similar to FIG. 38 with the base rotating hinge component or cover 208 (see FIG. 44) removed and in order to better illustrate the composite spring 230 which can again be fabricated or molded from any material utilizing oriented strand fibers, again such as including not limited to fiberglass, carbon fiber or Kevlar®. As has been further described, the spring 230 is configured to engage both the arcuate surface of the cam feature 244 and detent locations 246/248 (defining the open and closed locations of the fuel door) and to provide each of opening resistance, locking position and closure force within the operating requirements of the total assembly, with the closure force and speed being controlled by the design cam geometry as further directed through the biasing force exerted against the inner protuberance or bump 236 of the spring 230.

FIG. 44 is a further illustration similar to FIG. 42 and showing the door bracket mounting system with attachable hinge component with width extending pin 242 for supporting between the concave pin seating locations 238/240 in the housing and in biasing contact with the end protuberance 236 of the composite spring 230. FIG. 45 is an illustration of the door portion of FIGS. 36-37 and depicting the snap coupling system for securing the door 210 and inside support portion to the hinge (again depicted by structure 214 on the rear face of the door), such as which can be accomplished after prior removal of the door for separate painting or the like.

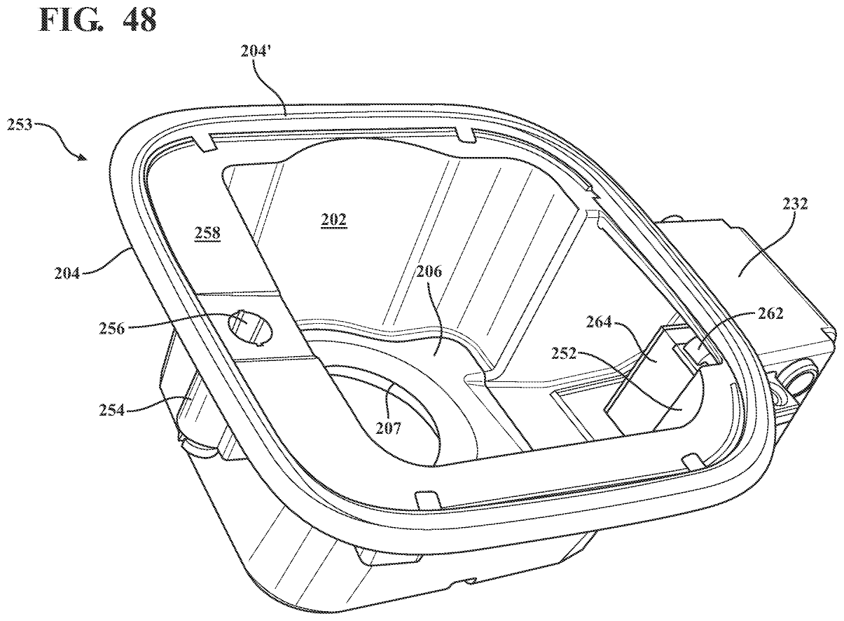

FIG. 46 is an illustration similar to FIG. 45 and depicting the hinge bracket 224 in exploded fashion to reveal the snap receptacle features (again fingers 216/218 and finger tabs 220/222) arrayed relative to the molded in snap features of the door inside support portion and tunable stability/locating features (see again windows 225 in bracket 224) for ensuring alignment and correct displacing engagement of the hinge. The bracket 224 further includes a curved intermediate profile between the receptacle engaging end for securing the door and in molded bracket, and the width extending pin 242. The curved profile of the bracket 224 further exhibits a pair of split ends (one of which is shown at 250 in FIG. 46) extending from a main body portion of the bracket 224 for straddling an inner support structure 252 (FIG. 48) incorporated into a bottom of the hinge receiving subset portion 232 of the main housing body 202.

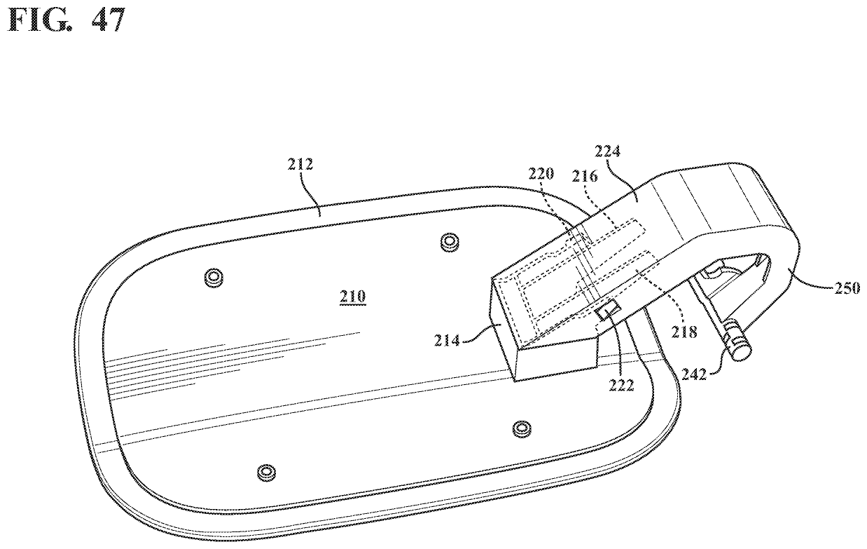

FIG. 47 succeeds FIG. 46 and displays the hinge bracket 224 in partial transparency in order to show the snaps engaged with the aligning windows in the sides of the perimeter defining walls of the hinge in combination with the guiding interior travel of the stability/locating features of the molded in portion of the hinge on the door rear surface;

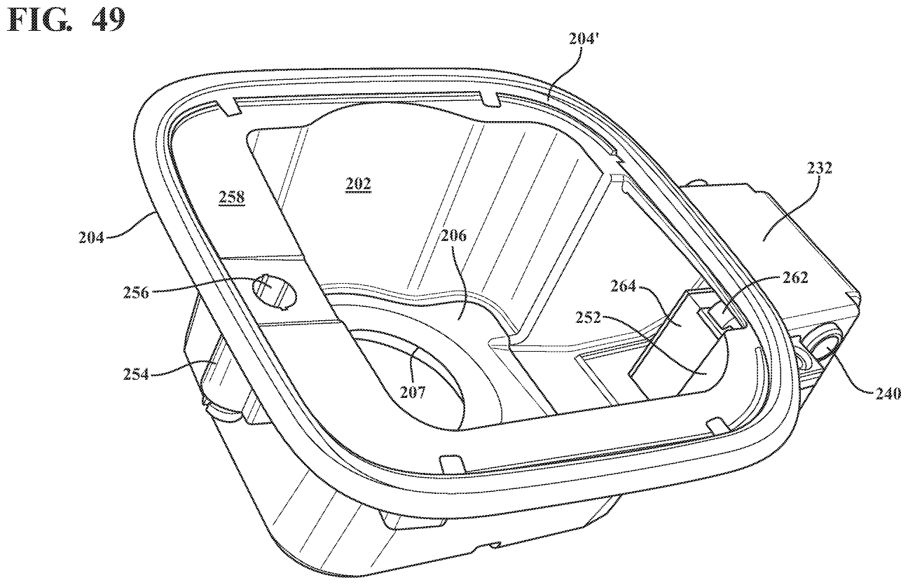

Proceeding to FIGS. 48-49, presented are a pair of perspective illustrations of a further variant of a fuel filler assembly, generally at 253 and which includes many of the common features depicted in the previous embodiment including the dual stage thermoplastic resin molded body with rigid 202 and softer shot 204 and 206 portions. As again shown, the softer second shot (injection molded) portion 204 can include an upper angled sealing lip or surface (204□) transitioning from the vehicle skin and to assist in seating against the inside trim edge 212 of the fuel door.

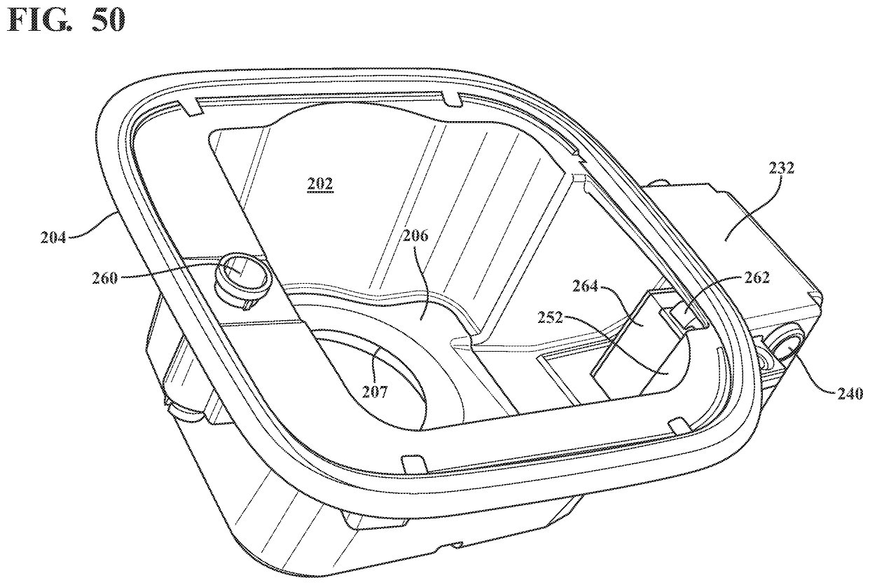

Also shown at 254 is a pocket housing configured (typically integrally molded) in a forward end of the main body (see also inlet receptacle 256 formed in upper lip edge 258 of the rigid housing 202) for receiving a variation of the push-push door release mechanism 260 (see as shown in FIG. 50). Without further explanation, the push-push component corresponds to the disclosure of related component 56 in FIG. 27 of the first embodiment 10 and which acts in combination with the pressing action of the door and the detent structure to transition the door between the closed and open positions.

A version of a cam roller tensioner component 262 is depicted which is similar to that shown at 28 in the first embodiment 10 and is configured at an upper surface of the inner support structure 252. Similar to the first embodiment, an additional thermoplastic material 264 is configured in the structural support 252 in order to provide additional biasing to the cam roller tensioner component 262 when coacting against the bracket detent components. Although not shown, a version of a spring (composite or otherwise) may be integrated into the hinge pocket located inner support structure 252. FIG. 50 is a rotated perspective of FIG. 48 with much of the filler pocket housing shown in transparency and to better illustrate the assembled door release mechanism supported within the molded actuator housing location.

Proceeding to FIGS. 51-52, a pair of illustrations are shown of a further variant of fuel filler housing support structure similar to FIGS. 6-8 of the first variant, and depicting a living hinge pivot pin retaining system which includes a molded living hinge door forming a portion of the main housing body which, when pivoted closed, acts as a pin retainer with opposing pairs of bearing surfaces for seating therebetween the width extending pin of the hinge bracket (according to any of the previously described variants). Common components to the embodiment shown in FIG. 7 (including living hinge 30 and opposing pairs of concave and pin capturing recesses 36/380 are shown and, upon the fold over cover or door (see at 208□ in comparison to 208 in FIG. 44), provide for both seating and permitting rotation of the hinge bracket 224. Additional features, such as aligning pairs of tabs 40/42 are again shown and which can receive suitable fasteners once the fold over door (as redesigned and shown at 208□) or similar hinge supported portion is secured to the hinge subset body 232 (see also arrow 266 in FIG. 52) provides the desired bearing surfaces between the pairs of semi-circular concave recesses for supporting the bracket pin 242 therebetween.

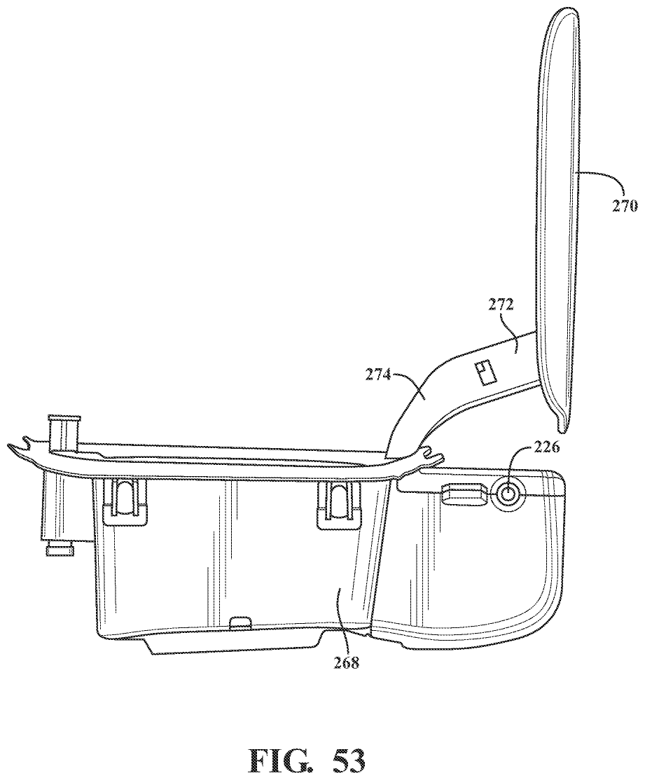

FIG. 53 is a side plan view of the door and hinge according to the variant of FIGS. 51-52 in the open rotated position about the living hinge axis and showing the concentric bearing surfaces for supporting the hinge bracket and door. This is further generally referenced by rigid body 268 (which can again include any of a single or dual shot thermoplastic material), along with a door 270 secured via in-molded first bracket portion 272 to the second hinge bracket 274, in turn including an end-most width extending pin 276 supported between the bearing surfaces defined by opposing pairs of semi-circular recesses configured in each of the cover portion and upper walls of the hinge receiving area of the housing.

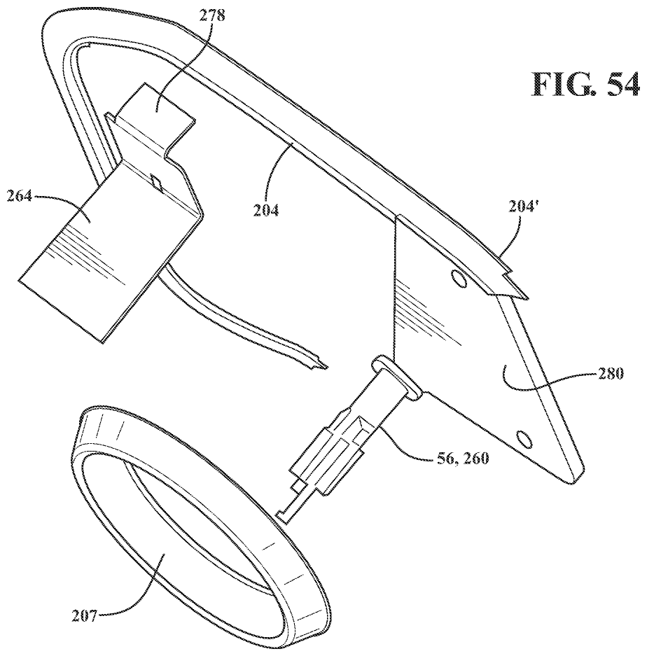

Finally, FIG. 54 is an exploded positional depiction of the soft molded components of the fuel filler pocket housing (see again at each of 204, 204□, 207, 264) in combination with the push-push door actuator component (again as previously shown at either at 56 or 260), and along with a further version of composite spring 278 which can be in-molded into the support structure 222 of FIG. 48. Also depicted at 280 is a portion of a redesign of the first hinge component (see also door underside securing portion shown at 16 in related FIG. 4).

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as □including□, □comprising□, □incorporating□, □consisting of□, □have□, □is□ used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, □first□, □second□, □third□, □primary□, □secondary□, □main□ or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A combination fuel filler pocket and hingedly attachable door assembly adapted to communicate with a fuel filler tube of a vehicle, comprising:
a recessed housing having an upper rim edge incorporated into an outer skin of the vehicle;
a door overlaying said upper rim edge in a closed position; and
a hinge bracket securing to an underside location of said door at a first end, said hinge bracket having a widthwise extending pin at a second end which is pivotally supported within capture recesses defined in a subset area of said body for permitting said door to be pivoted away from said upper rim edge to an open position.

2. The invention as described in claim 1, further comprising a detent cam mechanism for biasing the door at each of the closed and open rotated positions.

3. The invention as described in claim 2, said detent cam mechanism further comprising a wedge shaped portion extending from said pivot pin and having first and second concave depressions formed therein which, upon selective alignment with a cam roller tensioner component supported within said body, providing said biasing for defining the closed and open positions.

4. The invention as described in claim 3, further comprising an interior superstructure configured within said subset area of said body for supporting said cam roller tensioner.

5. The invention as described in claim 4, further comprising a composite thermoplastic spring integrated into said interior superstructure underneath said cam roller tensioner, said spring engaging with both said cam roller tensioner and said wedge shaped portion of said detent cam mechanism for providing opening resistance in combination with locking position and closure force.

6. The invention as described in claim 5, said composite spring further comprising oriented strand fibers not limited to fiberglass, carbon, fiber or Kevlar.

7. The invention as described in claim 3, further comprising a recess formed in a lip of said body proximate said upper rim edge and defining a separate housing for receiving a door actuator component, said component having a flattened upper end button profile which, upon being contacted by downward pressing of said door, exerting a return bias against said door and, in conjunction with said cam tensioner roller and detent components, influencing said door toward the open position.

8. The invention as described in claim 1, further comprising each of said housing and door being produced by successive injection moldings of a thermoplastic material.

9. The invention as described in claim 1, said hinge bracket further comprising a first subset component secured to said door, said first component being removably engageable with a second subset component terminating in said widthwise extending pin pivotally supported with respect to said body.

10. The invention as described in claim 9, further comprising locating features associated with said first subset component which inter-engage with receiving structure of said second subset component to secure said door to said assembly.

11. The invention as described in claim 10, said locating features further comprising biasing tabs extending from said first subset component which are received within an opposing open end of said second subset component.

12. The invention as described in claim 11, further comprising side windows configured in said second subset component proximate said open receiving end, through which are snap engaged said biasing tabs.

13. The invention as described in claim 1, said subset area of said body further comprising a fold-over door attached by a living hinge to define said capture recesses for pivotally supporting said widthwise extending pin and, upon closing, acting as a retainer and bearing surface to said width extending pin end of said hinge bracket.

14. The invention as described in claim 7, said door actuator component further comprising a diamond shaped travel passageway formed within a lower region of said component, an elongated tang secured within said separate housing and having an upper angled end seating within said passageway, an elongated compression pad supported within a recessed interior of the receiving passageway and exerting a continued upward bias against said actuator component during up/down travel against said engaging tang.

15. A combination fuel filler pocket and hingedly attachable door assembly communicating with a fuel filler tube of a vehicle, comprising:
a recessed housing constructed of a first rigid thermoplastic injection molded material;
at least one second shot of a softer thermoplastic material being applied to said first rigid material and including at least an upper rim edge portion of said housing opposing an inside facing rim edge of a door overlaying in a closed position;
a hinge bracket securing to an underside location of said door at a first end, said hinge bracket having a widthwise extending pin at a second end which is pivotally supported within capture recesses defined in a subset area of said body for permitting said door to be pivoted away from said upper rim edge to an open position; and
a detent cam mechanism for biasing the door at each of the closed and open rotated positions, said cam mechanism including a wedge shaped portion extending from said pivot pin with first and second concave depressions formed therein which, upon selective alignment with a cam roller tensioner component supported within said body, providing said biasing for defining the closed and open positions.

16. The invention as described in claim 15, further comprising an interior superstructure configured within said subset area of said body for supporting said cam roller tensioner, a composite thermoplastic spring integrated into said interior superstructure underneath said cam roller tensioner, said spring engaging with both said cam roller tensioner and said wedge shaped portion of said detent cam mechanism for providing opening resistance in combination with locking position and closure force.

17. The invention as described in claim 15, further comprising a recess formed in a lip of said body proximate said upper rim edge and defining a separate housing for receiving a door actuator component, said component having a flattened upper end button profile which, upon being contacted by downward pressing of said door, exerting a return bias against said door and, in conjunction with said cam tensioner roller and detent components, influencing said door toward the open position.

18. The invention as described in claim 15, said hinge bracket further comprising a first subset component secured to said door, said first component being removably engageable with a second subset component terminating in said widthwise extending pin pivotally supported with respect to said body.

19. The invention as described in claim 15, said subset area of said body further comprising a fold-over door attached by a living hinge to define said capture recesses for pivotally supporting said widthwise extending pin and, upon closing, acting as a retainer and bearing surface to said width extending pin end of said hinge bracket.

20. The invention as described in claim 17, said door actuator component further comprising a diamond shaped travel passageway formed within a lower region of said component, an elongated tang secured within said separate housing and having an upper angled end seating within said passageway, an elongated compression pad supported within a recessed interior of the receiving passageway and exerting a continued upward bias against said actuator component during up/down travel against said engaging tang.
